(19) United States
(12) Patent Application Publication
(10) Pub. No.: US 2021/0155269 A1
(43) Pub. Date: May 27, 2021

(54) INFORMATION PROCESSING DEVICE, MOBILE DEVICE, INFORMATION PROCESSING SYSTEM, METHOD, AND PROGRAM

(71) Applicant: SONY SEMICONDUCTOR SOLUTIONS CORPORATION, KANAGAWA (JP)

(72) Inventor: EIJI OBA, KANAGAWA (JP)

(21) Appl. No.: 17/047,044

(22) PCT Filed: Mar. 15, 2019
(86) PCT No.: PCT/JP2019/010778

§ 371 Date: Oct. 12, 2020

(30) Foreign Application Priority Data
Apr. 26, 2018 (JP) 2018-085235

(51) Int. Cl. B60W 60/00; G05D 1/00; H04W 4/02; H04W 4/44; B60W 40/09; B60W 50/16; G01C 21/00

(52) U.S. Cl. CPC B60W 60/0053; G05D 1/0011; H04W 4/023; H04W 4/44; B60W 60/0059; B60W 2050/146; B60W 50/16; G01C 21/3889; B60W 60/0057; B60W 2540/30; B60W 40/09

(57) ABSTRACT

To implement a configuration to execute entry control to the high-speed automatic driving permissible area according to the determination result of the manual driving ability of the driver. An entry of the mobile device from a low-speed automatic driving permissible area to the high-speed automatic driving permissible area is controlled on the basis of the determination result of the manual driving ability at a high speed of the driver. Moreover, the entry control is executed according to the presence or absence of a setting of remote driving control of the mobile device from a leading vehicle or a driving control center. In a case where there is no manual driving ability at a high speed of the driver of the mobile device, and moreover in a case where there is no remote support setting at a high speed of the mobile device, the data processing unit prohibits an entry to the high-speed automatic driving permissible area. The data processing unit determines the manual driving ability at a high speed of the driver of the mobile device on the basis of monitoring information including operation information of the driver in the low-speed automatic driving permissible area.

### TECHNICAL FIELD

The present disclosure relates to an information processing device, a mobile device, an information processing system, a method, and a program. More specifically, the present disclosure relates to an information processing device, a mobile device, an information processing system, a method, and a program for performing switching control of automatic driving and manual driving.

### BACKGROUND ART

Recently, technological development related to automatic driving has been actively carried out. The automatic driving technologies enable automatic driving on roads using a position detection means provided in a vehicle (automobile) or various sensors necessary for detecting surrounding environments, cognitive judgment which affect a traveling route of the automobile, and the like. Rapid spread of the technologies is expected in the future. Note that, for example, Patent Document 1 (Japanese Patent Application Laid-Open No. 2015-141051) discloses a conventional technology related to an automatic drive system.

However, at present, the automatic driving is in the development stage, and to enable 100% seamless automatic driving in an environment where various general vehicles are travelable, considerable investment in infrastructure and time are required. Considering the convenience of vehicles such as conventional private cars, it is necessary to allow free movement between any two points. For this purpose, it is predicted that, for a while, traveling by appropriately switching the automatic driving and manual driving by a driver is required according to the infrastructure and road conditions.

In the case where a person steers a car, it is necessary to accurately perform three processes of “cognition, judgment, and operation” for various events that occur as the vehicle travels. In a conventional manually driven vehicle, the driver performs all of these processes. In future automatic driving vehicles, an automatic drive system that replace humans will perform the “cognition, judgment, and operation”.

In the case where the automatic drive system performs the “cognition, judgment, and operation”, the system needs appropriate environmental cognitive ability, judgment ability for all the situations, and coping ability based on the judgment. Furthermore, in order for the automatic driving vehicle to perform safe automatic driving, it is necessary that a road on which the vehicle travels or the like has a configuration and equipment for realizing the safe automatic driving. Specifically, it is necessary to improve the infrastructure such that there is surely a configuration that can be sensed by a sensor of the automatic driving vehicle, for example. Furthermore, to prevent an accident at a normal traveling speed of the vehicle, it is necessary to perform “cognition, judgment, and operation” at a level not determined to be a risk by time to collision (TTC) that is a risk level evaluation value corresponding to automatic driving, that is, a risk evaluation value such as TTC indicating a value obtained by dividing a distance to a vehicle ahead by a relative speed.

At present, to cope with the automatic traveling using the limited handling capabilities of “cognition, judgment, and operation”, for example, an infrastructure using a so-called local dynamic map (LDM) needs to be constructed, in which road environment information, for example, travel map information of roads on which the vehicle travels is updated with high density on a constant basis. Although feasibility of automatic driving is being realized on some roads, it is difficult to install the equipment required for automatic driving on all roads. Therefore, at present, it is extremely difficult to allow unrestricted automatic driving on all roads.

Furthermore, even in a road section where automatic driving is available, switching to manual driving may be required in an emergency such as an accident. In such a case, if the driver of the automatic driving vehicle lacks an ability of manual driving, the driver cannot switch the automatic driving to the manual driving, and measures such as an emergency stop needs to be taken. Frequent occurrence of such emergency measures causes a problem of traffic congestion.

Furthermore, even in a road section where automatic driving is available, switching to manual driving may be required in an emergency such as an accident. In such a case, if the driver of the automatic driving vehicle lacks an ability of manual driving, the driver cannot switch the automatic driving to the manual driving, and measures such as an emergency stop needs to be taken. Frequent occurrence of such emergency measures causes a problem of traffic congestion. In light of the above, when vehicles travel on a main highway with a large amount of road traffic, the number of vehicles that make an emergency stop needs to be controlled to be low. Otherwise, the social infrastructure is unfavorably hindered.

However, meanwhile, when a vehicle travels at a low speed, deceleration and stop of the vehicle becomes easy and the possibility of use can be increased, even if any one of the handling capabilities of “cognition, judgment, and operation” is inferior. For example, an automatic transportation system for moving goods on school grounds, a low speed automatic driving cart on a golf course, an unmanned fully automatic driving vehicle in a limited environment such as a shopping mall can be easily realized. Moreover, such a low-speed automatic driving vehicle can be a transportation means limited to low-speed traveling in a difficult-to-move area such as a depopulated area.

That is, in the case where the handling capacity of the automatic driving system is limited, one solution is to keep the traveling speed low and set the vehicle speed such that the vehicle can be decelerated and stopped immediately to avoid an accident, for example. At present, with respect to a low-speed automatic driving vehicle equipped with a device for determining a surrounding environment, an experiment with a limited range of use has been started.

However, in a vehicle that secures safety only at low speeds, the range of use of the vehicle is limited. This is because when a low-speed traveling vehicle travels on a main road that forms an arterial route for goods and movement, it causes traffic jams and social activity stagnation. Meanwhile, if the usable area is limited, the vehicle cannot be used as the transportation means between any two points, which is the convenience of the vehicle described above, and the merit as a transportation means is lost. As a result, there is a possibility that the moving range, which has been realized in the conventional manually driving vehicle, is impaired.

### CITATION LIST

### Patent Document

Patent Document 1: Japanese Patent Application Laid-Open No. 2015-141051

### SUMMARY OF THE INVENTION

### Problems to be Solved by the Invention

The present disclosure has been made in view of the above-described problems, for example, and an object of the present disclosure is to provide an information processing device, a mobile device, an information processing system, a method, and a program that enable control of entry to an automatic driving permissible area according to a manual driving ability of a driver under an environment where automatic driving permissible areas and automatic driving non-permissible areas are mixed.

Furthermore, in an embodiment of the present disclosure, an object is to provide an information processing device, a mobile device, an information processing system, a method, and a program for performing entry control according to a manual driving ability of a driver in a case where a vehicle capable of automatic driving at a low speed and automatic driving at a high speed enters a high-speed automatic driving permissible area from a low-speed automatic driving permissible area.

### Solutions to Problems

The first aspect of the present disclosure resides in an information processing device including a data processing unit configured to determine a manual driving ability of a driver of a mobile device and execute entry control according to a determination result when the mobile device enters an automatic driving permissible area.

Moreover, the second aspect of the present disclosure resides in

a mobile device including:

an environment information acquisition unit configured to detect approach of the mobile device to an entry position from a low-speed automatic driving permissible area to a high-speed automatic driving permissible area; and

a data processing unit configured to determine a manual driving ability at a high speed of a driver of the mobile device and execute entry control according to a determination result when the mobile device enters a high-speed automatic driving permissible area from a low-speed automatic driving permissible area.

Moreover, the third aspect of the present disclosure resides in

an information processing system including a server configured to distribute a local dynamic map (LDM) and a mobile device configured to receive distribution data of the server, in which

the server

distributes the local dynamic map (LDM) on which area setting information regarding a low-speed automatic driving permissible area and a high-speed automatic driving permissible area, and

the mobile device includes

a communication unit that receives the local dynamic map (LDM), and

a data processing unit that determines a manual driving ability at a high speed of a driver of the mobile device and executes entry control according to a determination result when the mobile device enters the high-speed automatic driving permissible area from the low-speed automatic driving permissible area.

Moreover, the fourth aspect of the present disclosure resides in

an information processing method executed in an information processing device, the information processing method including

by a data processing unit, determining a manual driving ability of a driver of a mobile device and executing entry control according to a determination result when the mobile device enters an automatic driving permissible area.

Moreover, the fifth aspect of the present disclosure resides in

a program for causing an information processing device to execute information processing including

causing a data processing unit to determine a manual driving ability of a driver of a mobile device and execute entry control according to a determination result when the mobile device enters an automatic driving permissible area.

Note that the program according to the present disclosure is, for example, a program that can be provided by a storage medium or a communication medium provided in a computer readable format to an information processing device or a computer system that can execute various program codes. By providing such a program in the computer readable format, processing according to the program is implemented on the information processing device or the computer system.

Still other objects, features, and advantages of the present disclosure will become clear from more detailed description based on examples and attached drawings of the present disclosure to be described below. Note that a system in the present specification is a logical aggregate configuration of a plurality of devices, and is not limited to devices having respective configurations within the same housing.

### Effect of the Invention

According to a configuration of an embodiment of the present disclosure, a configuration to execute entry control to a high-speed automatic driving permissible area according to a determination result of a manual driving ability of a driver is implemented.

Specifically, for example, an entry of the mobile device from a low-speed automatic driving permissible area to the high-speed automatic driving permissible area is controlled on the basis of the determination result of the manual driving ability at a high speed of the driver. Moreover, the entry control is executed according to the presence or absence of a setting of remote driving control of the mobile device from a leading vehicle or a driving control center. In a case where there is no manual driving ability at a high speed of the driver of the mobile device, and moreover in a case where there is no remote support setting at a high speed of the mobile device, the data processing unit prohibits an entry to the high-speed automatic driving permissible area. The data processing unit determines the manual driving ability at a high speed of the driver of the mobile device on the basis of monitoring information including operation information of the driver in the low-speed automatic driving permissible area.

With the present configuration, the configuration to execute entry control to the high-speed automatic driving permissible area according to the determination result of the manual driving ability of the driver is implemented.

Note that the effects described in the present specification are merely examples and are not limited, and additional effects may be exhibited.

### BRIEF DESCRIPTION OF DRAWINGS

FIG. 1 is a diagram for describing an outline of a configuration and processing of the present disclosure.

FIG. 2 is a diagram for describing an outline of a configuration and processing of the present disclosure.

FIG. 3 is a diagram for describing a configuration example of a mobile device of the present disclosure.

FIG. 4 is a diagram for describing an example of data displayed on a display unit of the mobile device of the present disclosure.

FIG. 5 is a diagram for describing a configuration example of the mobile device according to the present disclosure.

FIG. 6 is a diagram for describing a configuration example of the mobile device according to the present disclosure.

FIG. 7 is a diagram for describing a sensor configuration example of the mobile device according to the present disclosure.

FIG. 8 is a diagram illustrating an example of a mode switching sequence from an automatic driving mode to a manual driving mode executed by the mobile device of the present disclosure.

FIG. 9 is a diagram illustrating a flowchart for describing a control sequence in a case of traveling in a low-speed automatic driving permissible area and a high-speed automatic driving permissible area.

FIG. 10 is a diagram illustrating a flowchart for describing a control sequence in the case of traveling in a low-speed automatic driving permissible area and a high-speed automatic driving permissible area.

FIG. 11 is a diagram illustrating a flowchart for describing a control sequence in the case of traveling in a low-speed automatic driving permissible area and a high-speed automatic driving permissible area.

FIG. 12 is a diagram illustrating a flowchart for describing a travel control sequence in the high-speed automatic driving permissible area.

FIG. 13 is graphs for describing a distribution example of a plurality of pieces of relationship information (observation plots) between an observable evaluation value corresponding to an observation value and a recovery delay time (=manual driving recoverable time), and a recovery ratio.

FIG. 14 is a graph for describing a manual driving recoverable time according to a type of processing (secondary task) executed by a driver in the automatic driving mode.

FIG. 15 is a diagram for describing a hardware configuration example of an information processing device.

### MODE FOR CARRYING OUT THE INVENTION

Hereinafter, an information processing device, a mobile device, an information processing system, a method, and a program of the present disclosure will be described in detail with reference to the drawings. Note that the description will be given according to the following items.

1. Outline of Configuration and Processing of Present Disclosure

2. Outline of Configurations and Processing of Mobile Device and Information Processing Device

3. Specific Configuration and Processing Example of Mobile Device

4. Mode Switching Sequence from Automatic Driving Mode to Manual Driving Mode

5. Control Processing Example in a Case of Traveling in Low-speed Automatic Driving Permissible Area and High-speed Automatic Driving Permissible Area.

6. Travel Control Sequence in High-Speed Automatic Driving Permissible Area

7. Specific Example of Manual Driving Recoverable Time Estimation Processing

8. Configuration Example of Information Processing Device

9. Conclusion of Configurations of Present Disclosure

### [1. Outline of Configuration and Processing of Present Disclosure]

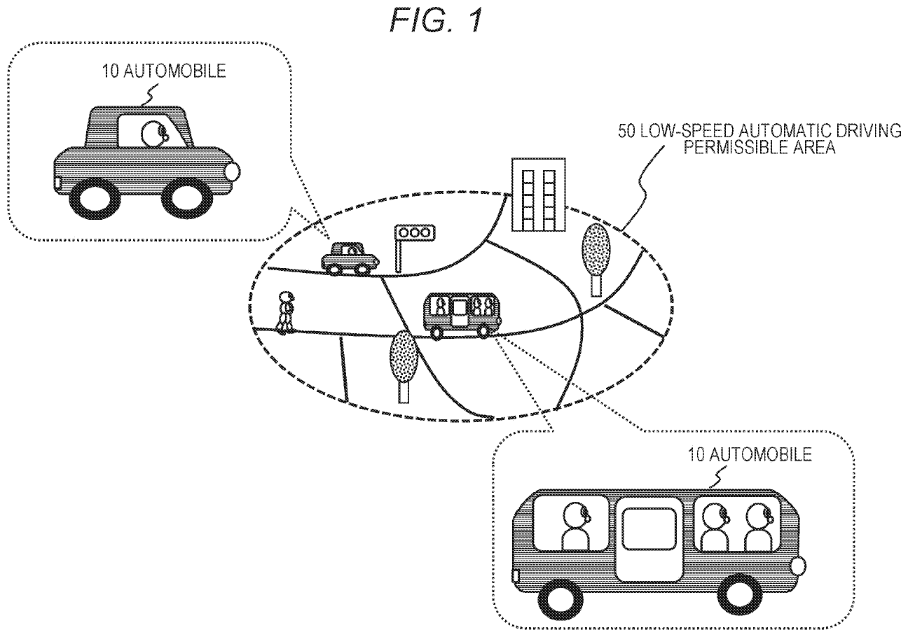

First, an outline of a configuration and processing of the present disclosure will be described with reference to FIG. 1 and the subsequent drawings. FIG. 1 illustrates an automobile 10 as an example of a mobile device of the present disclosure.

The automobile 10 of the present disclosure is, for example, an automobile capable of traveling while switching automatic driving and manual driving. Moreover, the automobile 10 of the present disclosure is an automobile capable of switching, for example, a low-speed automatic driving mode of 10 to 20 k/h or less, and a high-speed automatic driving mode at a high speed of 20 k/h or more, which is similar to a general vehicle. Specific examples of the automobile 10 include, for example, an automatic driving vehicle used by the elderly and a vehicle such as a low-speed bus that circulates in a specific area.

As illustrated in FIG. 1, the automobile 10 performs the automatic driving at the low-speed automatic driving mode of 10 to 20 k/h or less in a predetermined low-speed automatic driving permissible area 50, for example.

The low-speed automatic driving permissible area 50 is, for example, an area where high-speed vehicles do not pass, such as a premise of a shopping center, a campus of a university, an airport, a golf course, an urban commercial area, or an area where the low-speed vehicle and the high-speed vehicle are separated from each other so that the low-speed vehicle can travel safely.

In this low-speed automatic driving permissible area 50, the automobile 10 such as the automatic driving vehicle used by the elderly or the low-speed bus circulating in a specific area can safely perform automatic driving in the low-speed automatic driving mode of about 10 to 20 k/h or less.

However, in the case where the automobile 10 travels outside the low-speed automatic driving permissible area 50, high-speed traveling is required similarly to general high-speed vehicles in order not to disturb traveling of the general high-speed vehicles.

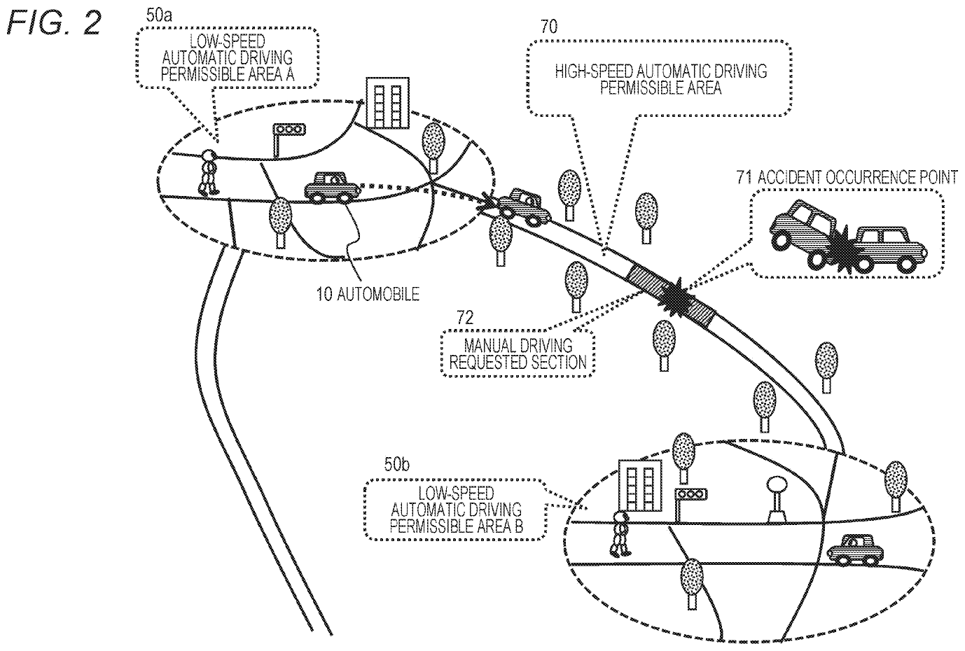

For example, as illustrated in FIG. 2, the automobile 10 in automatic driving at the low-speed automatic driving mode in a low-speed automatic driving permissible areas A 50a travels to another low-speed automatic driving permissible area B 50b at a distant place, the automobile 10 needs to pass through connecting roads including a general road, an expressway, and the like connecting these areas. This connecting road is a high-speed automatic driving permissible section 70 where the automatic driving in the high-speed automatic driving mode is allowed, as illustrated in FIG. 2. If the vehicle travels at a low speed on this road, it will disturb traveling of general high-speed vehicles, and may cause traffic congestion or the like.

As described above, the automobile 10 is an automobile capable of switching the low-speed automatic driving mode of 10 to 20 k/h or less and the high-speed automatic driving mode at a high speed of 20 k/h or more, which is similar to a general vehicle. Therefore, the automobile 10 can perform the automatic driving at a speed similar to the other general vehicles by switching the mode to the high-speed automatic driving mode in the high-speed automatic driving permissible section 70.

However, in the high-speed automatic driving permissible section 70, switching from the automatic driving to the manual driving is necessary when an emergency occurs such as an accident. In this case, the driver needs to perform high-speed manual driving. For example, as illustrated in FIG. 2, a section near an accident occurrence point 71 is set as a manual driving required section 72.

When such a situation occurs, there is a possibility that the driver of the automobile 10 cannot perform the manual driving at a high speed similarly to the general vehicles, in the case where the driver of the automobile 10 is an elderly person, for example. If the driver of the automatic driving vehicle lacks the ability of manual driving, the driver cannot switch the automatic driving to the manual driving, and measures such as an emergency stop needs to be taken. If such emergency measures occur frequently, traffic congestion will occur.

As described above, in the case where a person steers a car, it is necessary to accurately perform the three processes of “cognition, judgment, and operation” for various events that occur as the vehicle travels. In a conventional manually driven vehicle, the driver performs all of these processes. In future automatic driving vehicles, an automatic drive system that replace humans will perform the “cognition, judgment, and operation”. In the case of performing the automatic driving at the high-speed automatic driving mode in the high-speed automatic driving permissible section 70 illustrated in FIG. 2, the automatic drive system performs the three processes of “cognition, judgment, and operation” and thus the driver does not need to perform the “cognition, judgment, and operation”.

However, when a section near the accident occurrence point 71 is set as the manual driving required section 72, due to occurrence of an accident or the like, as illustrated in FIG. 2, the driver needs to start the manual driving and is required to accurately perform the three processes of “cognition, judgment, and operation”. However, in the case where the driver of the automobile 10 is an elderly person, for example, the driver may not be able to accurately perform the three processes of “cognition, judgment, and operation”. In this case, the driver cannot start safe manual driving. When such a situation occurs, switching to the manual driving cannot be performed, and measures such as emergency stop need to be taken, which causes traffic congestion.

The present disclosure prevents occurrence of such problems, and performs entry control according to a manual driving ability of a driver to realize smooth traveling in a high-speed automatic driving permissible area in a case where a vehicle capable of automatic driving at a low speed and automatic driving at a high speed enters the high-speed automatic driving permissible area from a low-speed automatic driving permissible area.

A configuration of the present disclosure is, for example to control entry to the “high-speed automatic driving permissible area” according to the manual driving ability of the driver under an environment where the “low-speed automatic driving permissible area” that is an automatic driving permissible area limited to a low speed and the other “high-speed automatic driving permissible area” are mixed.

In the present specification, an area where the automatic driving is permitted is called “automatic driving permissible area”. The “automatic driving permissible area” includes, for example, a section of a shopping center, one town having a plurality of roads, one road, or the like. One type of “automatic driving permissible area” is “automatic driving permissible section”. The “automatic driving permissible section” is one road section where automatic driving is permitted. That is, the “automatic driving permissible area” including only one road section is called “automatic driving permissible section”. Note that the “automatic driving permissible area” is not a prohibited area for manual driving, and manual driving is also permitted.

As described above, in the present specification, the automatic driving permissible area limited to a low speed is called “low-speed automatic driving permissible area”. Meanwhile, roads (areas or sections) not corresponding to the “low-speed automatic driving permissible area” are described as “high-speed automatic driving permissible areas” for convenience.

The “high-speed automatic driving permissible area” is an area required to travel at a traveling speed similar to general manual driving vehicles. However, it is not assumed that high-speed automatic driving is always required. Such an area is described as “high-speed automatic driving permissible area” in comparison with the automatic driving permissible area limited to a low speed. That is, automatic driving at a high speed may be or may not be included. Furthermore, the case of traveling in a section where only the manual driving is required is not excluded.

For example, a section where the manual driving is required, a section where the driver can always pass in the automatic driving mode with the driver's attention as long as the driver is always in a steering recoverable state, and the like are also included. So-called general roads, highways, and the like are also included.

Note that examples of the case where the automatic driving vehicle cannot travel at an equivalent speed to general vehicles on a main road while fully keeping the automatic driving include a case caused by the capabilities of “cognition, judgment, and operation” of the automatic drive system for the surrounding environment, and a case determined by lack of provision of update information of a highly fresh local dynamic map (LDM) or its maintenance status, for example. There are various situations.

Therefore, in the present specification, areas including roads where general vehicles such as manual driving vehicles pass through and which can serve as main roads are collectively called “high-speed automatic driving permissible area”.

In the case where the vehicle can be stopped at any time, the time for the system to perform “cognition, judgment, and operation” becomes sufficient and the system can perform appropriate processing. Therefore, even if the performance required for the automatic drive system is limited, it can be practically used. Under these assumptions, the automatic traveling is being commercialized limited to closed sections. In the meantime, if the vehicle is moved at a higher speed, the capabilities of executing the “cognition, judgment, and operation” at a high speed are required.

Even if the high-speed execution of “cognition, judgment, and operation” is enabled by increasing the performance of the vehicle, it is not always possible to freely move arbitrary two points by automatic driving in a case where the infrastructure is inadequate or a case where the LDM is not constantly updated.

Meanwhile, for so-called vulnerable people in areas with very poor public transportation, speed of travel is not always a top priority for transportation moving between two points. Even if the vehicle is traveling at a low speed as compared with ordinary general vehicles, the convenience can be sufficiently improved. Especially in depopulated areas or the like having no public transportation, or for elderly people who do not have shops in the neighborhood even in urban areas, securing transportation is a vital issue.

### [2. Outline of Configurations and Processing of Mobile Device and Information Processing Device]

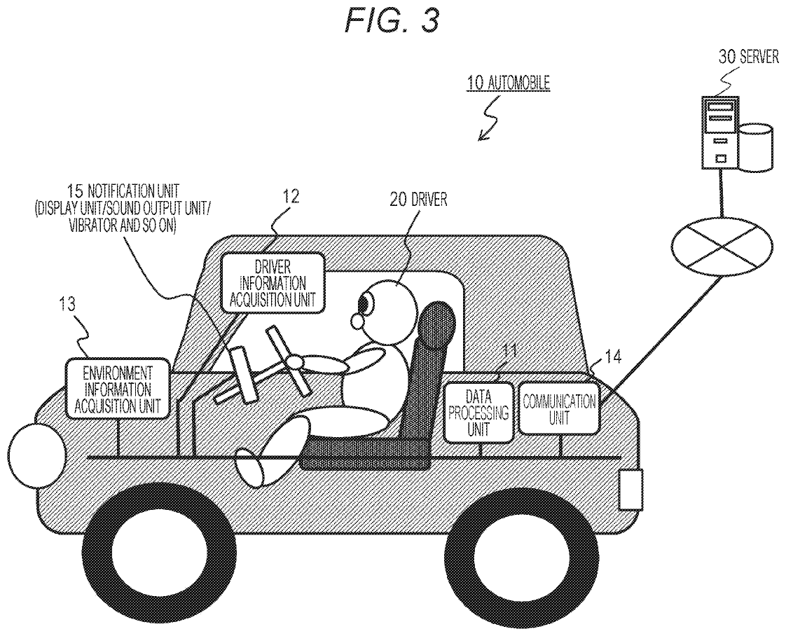

Configurations and processing of the mobile device and an information processing device mountable to the mobile device of the present disclosure will be described with reference to FIG. 3 and the subsequent drawings.

FIG. 3 is a diagram illustrating a configuration example of an automobile 10 that is an example of the mobile device of the present disclosure.

An information processing device of the present disclosure is mounted to the automobile 10 illustrated in FIG. 3.

The automobile 10 illustrated in FIG. 3 is an automobile capable of driving in two driving modes of the manual driving mode and the automatic driving mode.

In the manual driving mode, traveling based on an operation of a driver 20, that is, an operation of a steering wheel (steering), an operation of an accelerator, a brake, or the like is performed.

Meanwhile, in the automatic driving mode, the operation by the driver 20 is unnecessary, and driving based on sensor information such as a position sensor and other ambient information detection sensors is performed.

The position sensor is, for example, a GPS receiver or the like, and the ambient information detection sensor is, for example, a camera, an ultrasonic sensor, a radar, a light detection and ranging or a laser imaging detection and ranging (LiDAR), a sonar, or the like.

Note that FIG. 3 is a diagram for describing an outline of the present disclosure and schematically illustrates main configuration elements. Detailed configurations will be described below.

As illustrated in FIG. 3, the automobile 10 includes a data processing unit 11, a driver information acquisition unit 12, an environment information acquisition unit 13, a communication unit 14, and a notification unit 15.

The driver information acquisition unit 12 acquires, for example, information for determining the arousal level of the driver, such as biometric information of the driver, and operation information of the driver. Specifically, for example, the driver information acquisition unit 12 includes a camera that captures a face image of the driver, a sensor that acquires motions of eyeballs and pupils or the like, a measurement sensor for temperature or the like, and an operation information acquisition unit for the operation units (steering wheel, accelerator, brake, and the like), and the like.

The environment information acquisition unit 13 acquires traveling environment information of the automobile 10. For example, image information of the front, rear, right, and left of the automobile, and surrounding obstacle information from the light detection and ranging or the laser imaging detection and ranging (LiDAR), the sonar, or the like.

The data processing unit 11 receives the driver information acquired by the driver information acquisition unit 12 and the environment information acquired by the environment information acquisition unit 13 as inputs, and calculates safety index values indicating whether or not the driver in the automatic driving vehicle is in a safe manual driving executable state, and moreover, whether or not the driver in the manual driving is executing safe driving, for example.

Moreover, for example, in the case where necessity of switching from the automatic driving mode to the manual driving mode arises, the data processing unit 11 executes processing of issuing notification for switching to the manual driving mode via the notification unit 15.

This notification processing timing is optimum timing calculated using the inputs from the driver information acquisition unit 12 and the environment information acquisition unit 13, for example.

That is, it is the timing when the driver 20 can start safe manual driving.

Specifically, in the case where the arousal level of the driver is high, the notification is issued immediately before the manual driving start time, for example, five seconds before. In the case where the arousal level of the driver is low, the notification is issued twenty seconds before the manual driving start time with a margin, for example. Specific calculation of the optimum timing for the notification will be described below.

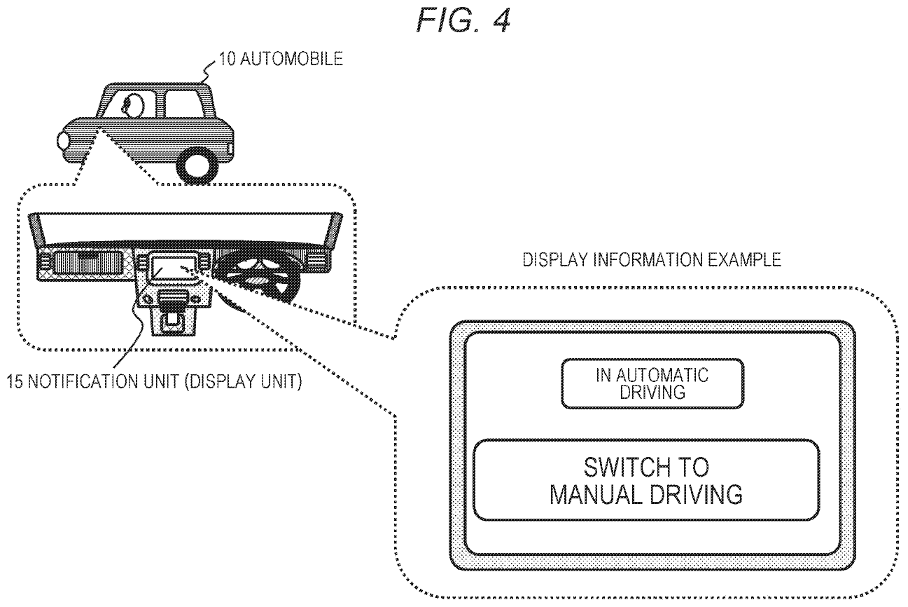

The notification unit 15 includes a display unit that displays the notification, a sound output unit, a steering wheel, or a vibrator of a seat. An example of warning display displayed on the display unit constituting the notification unit 15 is illustrated in FIG. 4.

As illustrated in FIG. 4, the notification unit (display unit) 15 displays the following items.

Driving mode information=“In automatic driving”,

Warning display=“Please switch driving to manual driving”

“In automatic driving” is displayed at the time of executing the automatic driving mode, and “In manual driving” is displayed at the time of executing the manual driving mode, in a display area of the driving mode information.

The display area of the warning display information is a display area where the following item is displayed while the automatic driving is executed in the automatic driving mode.

“Please switch driving to manual driving”

Note that the automobile 10 has a configuration capable of communicating with a server 30 via the communication unit 14, as illustrated in FIG. 3.

For example, part of processing of calculating appropriate time of a notification output in the data processing unit 11 can be performed by the server 30.

### [3. Specific Configuration and Processing Example of Mobile Device]

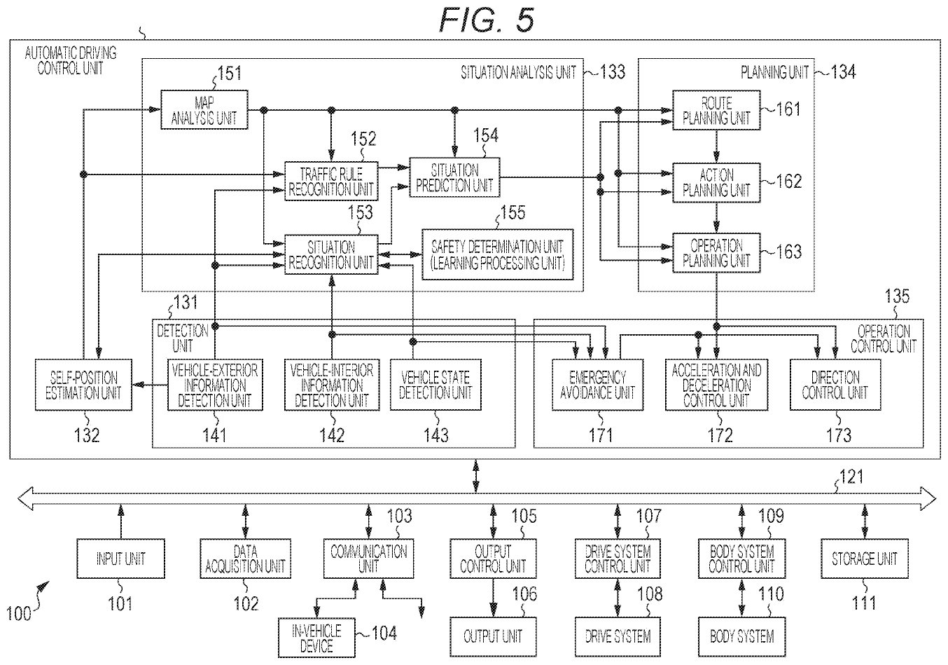

Next, a specific configuration and a processing example of the mobile device corresponding to the automobile 10 of the present disclosure will be described with reference to FIG. 5 and the subsequent drawings.

FIG. 5 illustrates a configuration example of a mobile device 100. Note that, hereinafter, in a case of distinguishing a vehicle provided with the mobile device 100 from other vehicles, the vehicle is referred to as user's own car or user's own vehicle.

The mobile device 100 includes an input unit 101, a data acquisition unit 102, a communication unit 103, an in-vehicle device 104, an output control unit 105, an output unit 106, a drive system control unit 107, a drive system 108, a body system control unit 109, a body system 110, a storage unit 111, and an automatic driving control unit 112.

The input unit 101, the data acquisition unit 102, the communication unit 103, the output control unit 105, the drive system control unit 107, the body system control unit 109, the storage unit 111, and the automatic driving control unit 112 are connected to one another via a communication network 121. The communication network 121 includes, for example, an on-board communication network conforming to an arbitrary standard such as a controller area network (CAN), a local interconnect network (LIN), a local area network (LAN), or FlexRay (registered trademark), a bus, and the like. Note that the units of the mobile device 100 may be directly connected without the communication network 121.

Note that, hereinafter, the case where the units of the mobile device 100 perform communication via the communication network 121, the description of the communication network 121 is omitted. For example, the case where the input unit 101 and the automatic driving control unit 112 perform communication via the communication network 121 will be simply described as the input unit 101 and the automatic driving control unit 112 performing communication.

The input unit 101 includes a device used by a passenger to input various data and instructions. For example, the input unit 101 includes operation devices such as a touch panel, a button, a microphone, a switch, and a lever, and an operation device capable of inputting data and instructions by a method other than a manual operation, such as voice or gesture. Furthermore, for example, the input unit 101 may be a remote control device using infrared rays or other radio waves, or an externally connected device such as a mobile device or a wearable device corresponding to the operation of the mobile device 100. The input unit 101 generates an input signal on the basis of the data, instructions, and the like input by the passenger, and supplies the input signal to each unit of the mobile device 100.

The data acquisition unit 102 includes various sensors that acquire data to be used for the processing of the mobile device 100, and supplies the acquired data to each unit of the mobile device 100.

For example, the data acquisition unit 102 includes various sensors for detecting the state of the user's own car. Specifically, for example, the data acquisition unit 102 is a gyro sensor, an acceleration sensor, an inertial measurement device (IMU), and sensors for detecting an operation amount of an accelerator pedal, an operation amount of a brake pedal, a steering angle of a steering wheel, an engine speed, a motor speed, a rotation speed of wheels, or the like.

Furthermore, for example, the data acquisition unit 102 includes various sensors for detecting information outside the user's own car. Specifically, for example, the data acquisition unit 102 includes imaging devices such as a time of flight (ToF) camera, a stereo camera, a monocular camera, an infrared camera, and other cameras. Furthermore, for example, the data acquisition unit 102 includes an environment sensor for detecting a weather, a meteorological phenomenon, or the like, and an ambient information detection sensor for detecting an object around the user's own car. The environment sensor includes, for example, a raindrop sensor, a fog sensor, a sunshine sensor, a snow sensor, and the like. The ambient information detection sensor includes, for example, an ultrasonic sensor, a radar device, a light detection and ranging or laser imaging detection and ranging (LiDAR) device, or a sonar.

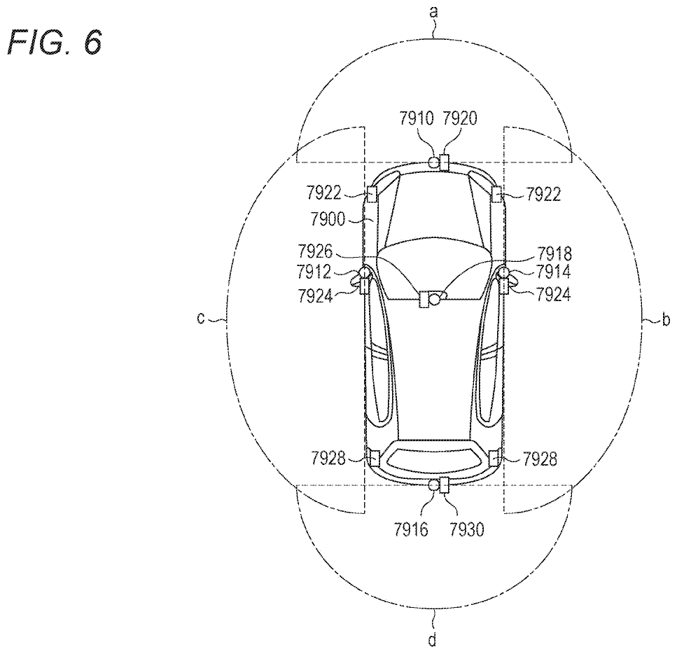

For example, FIG. 6 illustrates an installation example of the various sensors for detecting external information of the user's own car. Each of imaging devices 7910, 7912, 7914, 7916, and 7918 is provided at at least one position of a front nose, side mirrors, a rear bumper, a back door, or an upper portion of a windshield in an interior of a vehicle 7900, for example.

The imaging device 7910 provided at the front nose and the imaging device 7918 provided at an upper portion of the windshield in an interior of the vehicle mainly acquire front images of the vehicle 7900. The imaging devices 7912 and 7914 provided at the side mirrors mainly acquire side images of the vehicle 7900. The imaging device 7916 provided at the rear bumper or the back door mainly acquires a rear image of the vehicle 7900. The imaging device 7918 provided at the upper portion of the windshield in the interior of the vehicle is mainly used for detecting a preceding vehicle, a pedestrian, an obstacle, a traffic signal, a traffic sign, a lane, or the like. Furthermore, in the future automatic driving, when the vehicle turns right or left, the imaging devices may be used in an extended manner up to pedestrians crossing a road beyond the right or left-turn road in a wider range or an object range near a crossing road when the vehicle turns right or left.

Note that FIG. 6 illustrates an example of capture ranges of the imaging devices 7910, 7912, 7914, and 7916. An imaging range a indicates an imaging range of the imaging device 7910 provided at the front nose, imaging ranges b and c respectively indicate imaging ranges of the imaging devices 7912 and 7914 provided at the side mirrors, and an imaging range d indicates an imaging range of the imaging device 7916 provided at the rear bumper or the back door. For example, a bird's-eye view image of the vehicle 7900 as viewed from above, an all-round stereoscopic display image surrounding a vehicle periphery with a curved plane, and the like can be obtained by superimposing image data imaged in the imaging devices 7910, 7912, 7914, and 7916.

Sensors 7920, 7922, 7924, 7926, 7928, and 7930 provided at the front, rear, side, corner, and upper portion of the windshield in the interior of the vehicle 7900 may be ultrasonic sensors or radars, for example. Sensors 7920, 7926, and 7930 provided at the front nose, the rear bumper, the back door, and the upper portion of the windshield in the interior of the vehicle 7900 may be an LiDAR, for example. These sensors 7920 to 7930 are mainly used for detecting a preceding vehicle, a pedestrian, an obstacle, and the like. Results of the detections may be further applied to improvement of stereoscopic object display of the bird's-eye view display and the all-round stereoscopic display.

Description of the configuration elements will be continued returning to FIG. 5. The data acquisition unit 102 includes various sensors for detecting a current position of the user's own car. Specifically, for example, the data acquisition unit 102 includes a global navigation satellite system (GNSS) receiver that receives a GNSS signal from a GNSS satellite.

Furthermore, for example, the data acquisition unit 102 includes various sensors for detecting information inside the vehicle. Specifically, for example, the data acquisition unit 102 includes an imaging device that images a driver, a biosensor that detects biometric information of the driver, a microphone that collects sound in a vehicle interior, and the like. The biosensor is provided on, for example, a seating surface, a steering wheel, or the like, and detects a sitting state of an occupant sitting on a seat or biometric information of the driver holding the steering wheel. As a vital signal, diversified observable data is available such as heart rate, pulse rate, blood flow, respiration, mind-body correlation, visual stimulation, EEG, sweating state, head posture behavior, eye, gaze, blink, saccade, microsaccade, fixation, drift, gaze, and iris pupil reaction. These activity observable information reflecting an observable driving state is aggregated as observable evaluation values estimated from observations, and recovery delay time characteristics associated with logs of the evaluation values are used as specific characteristics to a recovery delay case of the driver for calculating the recovery notification timing by a safety determination unit (learning processing unit) 155 to be described below.

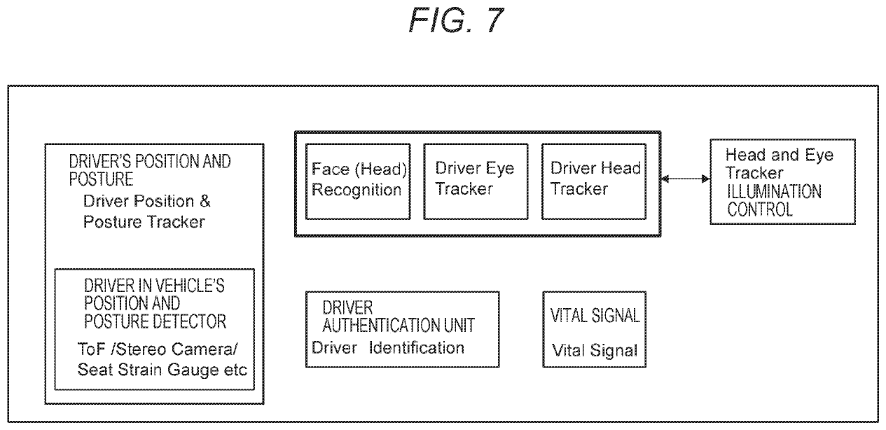

FIG. 7 illustrates an example of various sensors for obtaining information of the driver inside the vehicle included in the data acquisition unit 102. For example, the data acquisition unit 102 includes a ToF camera, a stereo camera, a seat strain gauge, and the like as detectors for detecting the position and posture of the driver. Furthermore, the data acquisition unit 102 includes a face recognition device (face (head) recognition), a driver eye tracker, a driver head tracker, and the like, as detectors for obtaining the activity observable information of the driver.

Furthermore, the data acquisition unit 102 includes a vital signal detector as a detector for obtaining activity observable information of the driver. Furthermore, the data acquisition unit 102 includes a driver authentication (driver identification) unit. Note that, as an authentication method, biometric authentication using a face, a fingerprint, an iris of a pupil, a voiceprint, or the like can be considered in addition to knowledge authentication using a password, a personal identification number, or the like.

The communication unit 103 communicates with the in-vehicle device 104 and various devices outside the vehicle, a server, a base station, and the like, transmits data supplied from each unit of the mobile device 100, and supplies received data to each unit of the mobile device 100. Note that a communication protocol supported by the communication unit 103 is not especially limited, and the communication unit 103 can support a plurality of types of communication protocols.

For example, the communication unit 103 performs wireless communication with the in-vehicle device 104, using a wireless LAN, Bluetooth (registered trademark), near field communication (NFC), a wireless USB (WUSB), or the like. Furthermore, for example, the communication unit 103 performs wired communication with the in-vehicle device 104, using a universal serial bus (USB), a high-definition multimedia interface (HDMI) (registered trademark), mobile high-definition link (MHL), or the like via a connection terminal (not illustrated) (and a cable if necessary).

Moreover, for example, the communication unit 103 communicates with a device (for example, an application server or a control server) existing on an external network (for example, the Internet, a cloud network, or a company specific network) via a base station or an access point. Furthermore, for example, the communication unit 103 communicates with a terminal (for example, a terminal of a pedestrian or a shop, or a machine type communication (MTC) terminal) existing in the vicinity of the user's own car, using a peer to peer (P2P) technology.

Moreover, for example, the communication unit 103 performs V2X communication such as vehicle to vehicle communication, vehicle to infrastructure communication, vehicle to home communication, and vehicle to pedestrian communication. Furthermore, for example, the communication unit 103 includes a beacon reception unit, and receives a radio wave or an electromagnetic wave transmitted from a wireless station or the like installed on a road, and acquires information such as a current position, congestion, traffic regulation, or required time. Note that pairing may be made with a vehicle traveling ahead while traveling in a section, which can be a leading vehicle, through the communication unit, and information acquired by a data acquisition unit mounted on the vehicle ahead may be acquired as pre-travel information and may be complementarily used as the data of the data acquisition unit 102 of the user's own car. In particular, this will be a means to secure the safety of following platooning vehicles, using platooning travel by the leading vehicle, for example.

The in-vehicle device 104 includes, for example, a mobile device (a tablet, a smartphone, or the like) or a wearable device of a passenger, an information device carried in or attached to the user's own car, and a navigation device for searching for a route to an arbitrary destination. Note that, considering that an occupant is not always fixed at a seat fixing position due to the spread of the automatic driving, the in-vehicle device 104 may be expanded to a video player, a game device, or any other devices that can be installed and removed from the vehicle in the future. In the present embodiment, an example in which presentation of information of points requiring intervention of the driver is limited to an appropriate driver has been described. However, the information may be further provided to a subsequent vehicle in platooning traveling or the like, or the information provision may be combined with remote travel support by constantly providing the information to an operation management center of passenger transportation shared buses and long-distance logistics commercial vehicles, as appropriate.

The output control unit 105 controls output of various types of information to the passenger of the user's own car or to the outside of the vehicle. The output control unit 105 controls output of visual information (for example, image data) and auditory information (for example, sound data) from the output unit 106 by generating an output signal including at least one of the visual information or the auditory information and supplying the output signal to the output unit 106, for example. Specifically, for example, the output control unit 105 synthesizes image data captured by different imaging devices of the data acquisition unit 102 to generate a bird's-eye view image, a panoramic image, or the like, and supplies an output signal including the generated image to the output unit 106. Furthermore, for example, the output control unit 105 generates sound data including a warning sound, a warning message, or the like for dangers of collision, contact, entry to a dangerous zone, or the like and supplies an output signal including the generated sound data to the output unit 106.

The output unit 106 includes a device capable of outputting the visual information or the auditory information to the passenger of the user's own car or to the outside of the vehicle. For example, the output unit 106 includes a display device, an instrument panel, an audio speaker, headphones, a wearable device such as a glasses-type display worn by the passenger, a projector, a lamp, or the like. The display device included in the output unit 106 may be, for example, a head-up display, a transmission-type display, or a display for displaying the visual information in a field of view of the driver, such as a device having an augmented reality (AR) display function, in addition to a device having a normal display.

The drive system control unit 107 controls the drive system 108 by generating various control signals and supplying the control signals to the drive system 108. Furthermore, the drive system control unit 107 supplies a control signal to each unit other than the drive system 108 to issue notification of a control state of the drive system 108, or the like, as needed.

The drive system 108 includes various devices related to the drive system of the user's own car. For example, the drive system 108 includes a drive force generation device for generating a drive force of an internal combustion engine or a drive motor, a drive force transmission mechanism for transmitting the drive force to the wheels, a steering mechanism for adjusting the steering angle, a braking device for generating a braking force, an antilock brake system (ABS), an electronic stability control (ESC), an electric power steering device, and the like.

The body system control unit 109 controls the body system 110 by generating various control signals and supplying the control signals to the body system 110. Furthermore, the body system control unit 109 supplies a control signal to each unit other than the body system 110 and notifies a control state of the body system 110, or the like, as needed.

The body system 110 includes various body-system devices mounted on a vehicle body. For example, the body system 110 includes a keyless entry system, a smart key system, a power window device, a power seat, a steering wheel, an air conditioner, various lamps (for example, headlights, backlights, brake lights, blinkers, fog lights, and the like), and the like.

The storage unit 111 includes, for example, a magnetic storage device such as a read only memory (ROM), a random access memory (RAM), and a hard disc drive (HDD), a semiconductor storage device, an optical storage device, a magneto-optical storage device, and the like. The storage unit 111 stores various programs, data, and the like used by each unit of the mobile device 100. For example, the storage unit 111 stores map data such as a three-dimensional high-precision map such as a dynamic map, a global map having less accuracy than the high-precision map but covering a large area, and a local map including information around the user's own car.

The automatic driving control unit 112 performs control related to the automatic driving such as autonomous driving or driving support. Specifically, for example, the automatic driving control unit 112 performs cooperative control for the purpose of implementing an advanced driver support system (ADAS) function including collision avoidance or shock mitigation of the user's own car, following travel based on a vehicular gap, vehicle speed maintaining travel, collision warning of the user's own car, lane out warning of the user's own car, and the like. Furthermore, for example, the automatic driving control unit 112 performs the cooperative control for the purpose of automatic driving of autonomous travel without depending on an operation of the driver. The automatic driving control unit 112 includes a detection unit 131, a self-position estimation unit 132, a situation analysis unit 133, a planning unit 134, and an operation control unit 135.

The detection unit 131 detects various types of information necessary for controlling the automatic driving. The detection unit 131 includes a vehicle exterior information detection unit 141, a vehicle interior information detection unit 142, and a vehicle state detection unit 143.

The vehicle exterior information detection unit 141 performs processing of detecting information outside the user's own car on the basis of data or signals from each unit of the mobile device 100. For example, the vehicle exterior information detection unit 141 performs detection processing, recognition processing, and tracking processing, for an object around the user's own car, and processing of detecting a distance to the object and a relative speed. Objects to be detected include, for example, vehicles, people, obstacles, structures, roads, traffic lights, traffic signs, road markings, and the like.

Furthermore, for example, the vehicle exterior information detection unit 141 performs processing of detecting an environment around the user's own car. The surrounding environment to be detected includes, for example, weather, temperature, humidity, brightness, road surface condition, and the like. The vehicle exterior information detection unit 141 supplies data indicating results of the detection processing to the self-position estimation unit 132, a map analysis unit 151, a traffic rule recognition unit 152, and a situation recognition unit 153 of the situation analysis unit 133, and an emergency avoidance unit 171 and the like of the operation control unit 135.

The information acquired by the vehicle exterior information detection unit 141 can be mainly supplied and received from an infrastructure in the case of a section stored in the local dynamic map, the section being constantly and importantly updated as a section where traveling by the automatic driving is available. Alternatively, the user's own vehicle may travel by constantly receiving information update in advance before entering a section, from a vehicle or a vehicle group traveling ahead in the section. Furthermore, in particular, for the purpose of more safely obtaining road information immediately before entering a section in a platooning travel, such as a case where the latest local dynamic map is not constantly updated by the infrastructure, road environment information obtained from a leading vehicle having entered the section may be further supplementarily used. In many cases, the section where the automatic driving is available depends on the presence or absence of prior information provided by these infrastructures. The information regarding availability of automatic driving on a route provided by an infrastructure is equivalent to providing an unseen track as so-called “information”. Note that the vehicle exterior information detection unit 141 is illustrated on the assumption that the vehicle exterior information detection unit 141 is mounted on the user's own vehicle for the sake of convenience. Pre-predictability at the time of traveling may be further improved by using information captured by a preceding vehicle as “information”.

The vehicle interior information detection unit 142 performs processing of detecting information inside the vehicle on the basis of data or signals from each unit of the mobile device 100. For example, the vehicle interior information detection unit 142 performs driver authentication processing and recognition processing, driver state detection processing, passenger detection processing, vehicle interior environment detection processing, and the like. The state of the driver to be detected includes, for example, physical condition, arousal level, concentration level, fatigue level, line-of-sight direction, detailed eyeball behavior, and the like.

Moreover, in the future, the driver is expected to completely taking the driver's hands off from driving and steering operation in the automatic driving, and the driver temporarily goes to sleep or starts doing another work, and the system needs to grasp how far the arousal recovery of consciousness required for driving recovery is progressing. That is, in a conventional driver monitoring system, a main detection means detects a decrease in consciousness such as drowsiness. However, in the future, the driver will be completely uninvolved in the driving and steering. Therefore, the system has no means for directly observing an intervention level of the driver from steering stability of a steering device and the like, and needs to observe a consciousness recovery transition required for driving from a state where an accurate consciousness level of the driver is unknown, grasp an accurate internal arousal state of the driver, and proceed in intervention in the manual driving of steering from the automatic driving.

Therefore, the vehicle interior information detection unit 142 mainly has two major roles. The first role is passive monitoring of the driver's state during the automatic driving. The second role is to detect the driver's periphery recognition, perception, judgment, and an operation ability of the steering device up to the level at which the manual driving is possible from when the recovery request is issued from the system to when the vehicle approaches a section of driving under caution. As control, a failure self-diagnosis of the entire vehicle may be further performed, and in a case where the function of the automatic driving is deteriorated due to partial malfunction of the automatic driving, the driver may be similarly prompted to recover to the manual driving early. The passive monitoring here refers to a type of detection means that does not require a conscious response reaction from the driver, and does not exclude devices that detect a response signal by transmitting physical radio waves, light, or the like from the device. That is, the passive monitoring refers to monitoring of the driver's unconscious state, such as during a nap, and classification that is not the driver's cognitive response is a passive system. The passive monitoring does not exclude active response devices that analyze and evaluate reflected or diffused signals obtained by emitting radio waves, infrared rays, or the like. Meanwhile, devices requesting the driver to give a conscious response requesting a response reaction are active systems.

The environment in the vehicle to be detected includes, for example, temperature, humidity, brightness, odor, and the like. The vehicle interior information detection unit 142 supplies data indicating results of the detection processing to the situation recognition unit 153 of the situation analysis unit 133 and the operation control unit 135. Note that, in the case where it is revealed that the driver cannot achieve the manual driving within an appropriate deadline after the driving recovery instruction to the driver is issued from the system, and it is determined that the takeover will not be in time even if deceleration control is performed in self-operation to give a time, an instruction is given to the emergency avoidance unit 171 and the like of the system, and deceleration, evacuation, and stop procedures are started for evacuating the vehicle. That is, even in a situation where the takeover cannot be in time as an initial state, it is possible to earn time to reach a takeover limit by starting the deceleration of the vehicle early.

The vehicle state detection unit 143 performs processing of detecting the state of the user's own car on the basis of data or signals from each unit of the mobile device 100. The state of the user's own car to be detected includes, for example, speed, acceleration, steering angle, presence or absence of abnormality, content of abnormality, state of driving operation, position and tilt of a power seat, a state of door lock, states of other in-vehicle devices, and the like. The vehicle state detection unit 143 supplies data indicating results of the detection processing to the situation recognition unit 153 of the situation analysis unit 133, the emergency avoidance unit 171 of the operation control unit 135, and the like.

The self-position estimation unit 132 performs processing of estimating the position, posture, and the like of the user's own car on the basis of the data and signals from the units of the mobile device 100, such as the vehicle exterior information detection unit 141 and the situation recognition unit 153 of the situation analysis unit 133. Furthermore, the self-position estimation unit 132 generates a local map (hereinafter referred to as self-position estimation map) to be used for estimating the self-position, as needed.

The self-position estimation map is a high-precision map using a technology such as simultaneous localization and mapping (SLAM), or the like. The self-position estimation unit 132 supplies data indicating a result of the estimation processing to the map analysis unit 151, the traffic rule recognition unit 152, and the situation recognition unit 153 of the situation analysis unit 133, and the like. Furthermore, the self-position estimation unit 132 causes the storage unit 111 to store the self-position estimation map.

The situation analysis unit 133 performs processing of analyzing the situation of the user's own car and its surroundings. The situation analysis unit 133 includes the map analysis unit 151, the traffic rule recognition unit 152, the situation recognition unit 153, a situation prediction unit 154, and a safety determination unit (learning processing unit) 155.

The map analysis unit 151 performs processing of analyzing various maps stored in the storage unit 111, using the data or signals from the units of the mobile device 100, such as the self-position estimation unit 132 and the vehicle exterior information detection unit 141, as needed, and builds a map including information necessary for automatic driving processing. The map analysis unit 151 supplies the built map to the traffic rule recognition unit 152, the situation recognition unit 153, the situation prediction unit 154, and a route planning unit 161, an action planning unit 162, and an operation planning unit 163 of the planning unit 134, and the like.

The traffic rule recognition unit 152 performs processing of recognizing a traffic rule around the user's own car on the basis of the data or signals from the units of the mobile device 100, such as the self-position estimation unit 132, the vehicle exterior information detection unit 141, and the map analysis unit 151. By the recognition processing, for example, the position and state of signals around the user's own car, the content of traffic regulation around the user's own car, a travelable lane, and the like are recognized. The traffic rule recognition unit 152 supplies data indicating a result of the recognition processing to the situation prediction unit 154 and the like.

The situation recognition unit 153 performs processing of recognizing the situation regarding the user's own car on the basis of the data or signals from the units of the mobile device 100, such as the self-position estimation unit 132, the vehicle exterior information detection unit 141, the vehicle interior information detection unit 142, the vehicle state detection unit 143, and the map analysis unit 151. For example, the situation recognition unit 153 performs processing of recognizing the situation of the user's own car, the situation around the user's own car, the situation of the driver of the user's own car, and the like. Furthermore, the situation recognition unit 153 generates a local map (hereinafter referred to as situation recognition map) used for recognizing the situation around the user's own car, as needed. The situation recognition map is, for example, an occupancy grid map.

The situation of the user's own car to be recognized is, for example, the position, posture, and motion of the user's own car (for example, speed, acceleration, moving direction, and the like), and a cargo load capacity and movement of the center of gravity of the vehicle body accompanying cargo loading, a tire pressure, a braking distance movement accompanying wear of a braking pad, allowable maximum deceleration braking to prevent cargo movement caused by load braking, and a centrifugal relaxation limit speed at the time of traveling on a curve with a liquid load, which are specific to the vehicle and determining motion characteristics of the user's own car. Moreover, the recovery start timing required for control is different depending on the conditions specific to the loading cargo, the characteristics specific to the vehicle itself, the load, and the like even if the road environment such as a friction coefficient of a road surface, a road curve, or a slope is exactly the same. Therefore, such various conditions need to be collected and learned, and reflected in the optimal timing for performing control. Simply observing and monitoring the presence or absence and content of abnormality of the user's own vehicle, for example, is not sufficient in determining the control timing according to the type of the vehicle and the load. To secure a certain level of safety in the transportation industry, or the like, according to unique characteristics of the load, parameters for determining addition of time for desired recovery may be set as a fixed value in advance, and it is not always necessary to uniformly set all notification timing determination conditions by self-accumulation learning.

The situation around the user's own car to be recognized include, for example, types and positions of surrounding stationary objects, types of surrounding moving objects, positions and motions (for example, speed, acceleration, moving direction, and the like), configurations of surrounding roads and conditions of road surfaces, as well as surrounding weather, temperature, humidity, brightness, and the like. The state of the driver to be recognized includes, for example, physical condition, arousal level, concentration level, fatigue level, line-of-sight motion, traveling operation, and the like. To cause the vehicle to safely travel, a control start point requiring measures greatly differs depending on a loading capacity mounted in a state specific to the vehicle, a chassis fixed state of a mounting unit, a decentered state of the center of gravity, a maximum decelerable acceleration value, a maximum loadable centrifugal force, a recovery response delay amount according to the state of the driver, and the like.

The situation recognition unit 153 supplies data indicating a result of the recognition processing (including the situation recognition map, as needed) to the self-position estimation unit 132, the situation prediction unit 154, and the like. Furthermore, the situation recognition unit 153 causes the storage unit 111 to store the situation recognition map.

The situation prediction unit 154 performs processing of predicting the situation regarding the user's own car on the basis of the data or signals from the units of the mobile device 100, such as the map analysis unit 151, the traffic rule recognition unit 152, and the situation recognition unit 153. For example, the situation prediction unit 154 performs processing of predicting the situation of the user's own car, the situation around the user's own car, the situation of the driver, and the like.

The situation of the user's own car to be predicted includes, for example, a behavior of the user's own car, occurrence of abnormality, a travelable distance, and the like. The situation around the user's own car to be predicted includes, for example, a behavior of a moving body around the user's own car, a change in a signal state, a change in the environment such as weather, and the like. The situation of the driver to be predicted includes, for example, a behavior and physical conditions of the driver, and the like.

The situation prediction unit 154 supplies data indicating a result of the prediction processing together with the data from the traffic rule recognition unit 152 and the situation recognition unit 153 to the route planning unit 161, the action planning unit 162, the operation planning unit 163 of the planning unit 134, and the like.

The safety determination unit (learning processing unit) 155 has a function as a learning processing unit that learns optimal recovery timing according to a recovery action pattern of the driver, the vehicle characteristics, and the like, and provides learned information to the situation recognition unit 153 and the like. As a result, for example, it is possible to present to the driver statistically determined optimum timing required for the driver to normally recover from the automatic driving to the manual driving at a predetermined ratio or more.

The route planning unit 161 plans a route to a destination on the basis of the data or signals from the units of the mobile device 100, such as the map analysis unit 151 and the situation prediction unit 154. For example, the route planning unit 161 sets a route to a destination specified from a current position on the basis of the global map. Furthermore, for example, the route planning unit 161 appropriately changes the route on the basis of situations of congestion, accidents, traffic regulations, construction, and the like, the physical conditions of the driver, and the like. The route planning unit 161 supplies data indicating the planned route to the action planning unit 162 and the like.

The action planning unit 162 plans an action of the user's own car for safely traveling in the route planned by the route planning unit 161 within a planned time on the basis of the data or signals from the units of the mobile device 100 such as the map analysis unit 151 and the situation prediction unit 154. For example, the action planning unit 162 makes a plan of starting, stopping, traveling directions (for example, forward, backward, turning left, turning right, turning, and the like), driving lane, traveling speed, passing, and the like. The action planning unit 162 supplies data indicating the planned action of the user's own car to the operation planning unit 163 and the like.

The operation planning unit 163 plans an operation of the user's own car for implementing the action planned by the action planning unit 162 on the basis of the data or signals from the units of the mobile device 100, such as the map analysis unit 151 and the situation prediction unit 154. For example, the operation planning unit 163 plans acceleration, deceleration, a traveling track, and the like. The operation planning unit 163 supplies data indicating the planned motion of the user's own car to an acceleration and deceleration control unit 172 and a direction control unit 173 of the operation control unit 135, and the like.

The operation control unit 135 controls the operation of the user's own car. The operation control unit 135 includes the emergency avoidance unit 171, the acceleration and deceleration control unit 172, and the direction control unit 173.

The emergency avoidance unit 171 performs processing of detecting an emergency situation such as collision, contact, entry into a danger zone, driver's abnormality, vehicle's abnormality, and the like on the basis of the detection results of the vehicle exterior information detection unit 141, the vehicle interior information detection unit 142, and the vehicle state detection unit 143. In the case where the emergency avoidance unit 171 detects occurrence of the emergency situation, the emergency avoidance unit 171 plans the operation of the user's own car for avoiding the emergency situation, such as sudden stop or sharp turn. The emergency avoidance unit 171 supplies data indicating the planned operation of the user's own car to the acceleration and deceleration control unit 172, the direction control unit 173, and the like.

The acceleration and deceleration control unit 172 performs acceleration and deceleration for implementing the operation of the user's own car planned by the operation planning unit 163 or the emergency avoidance unit 171. For example, the acceleration and deceleration control unit 172 calculates a control target value of a drive force generation device or a braking device for implementing the planned acceleration, deceleration, or sudden stop, and supplies a control command indicating the calculated control target value to the drive system control unit 107. Note that, there are two main cases where an emergency situation occurs. That is, there are a case where an unexpected accident has occurred due to a sudden reason during the automatic driving on a road on a traveling route, which is originally supposed to be safe according to the local dynamic map or the like acquired from an infrastructure and an emergency recovery cannot be in time, and a case where the driver has a difficulty in accurately recovering to the manual driving from the automatic driving.

The direction control unit 173 controls a direction for implementing the operation of the user's own car planned by the operation planning unit 163 or the emergency avoidance unit 171. For example, the direction control unit 173 calculates a control target value of a steering mechanism for implementing the traveling track or sharp turn planned by the operation planning unit 163 or the emergency avoidance unit 171, and supplies a control command indicating the calculated control target value to the drive system control unit 107.

[4. Mode Switching Sequence from Automatic Driving Mode to Manual Driving Mode]

Next, a takeover sequence from the automatic driving mode to the manual driving mode will be described.

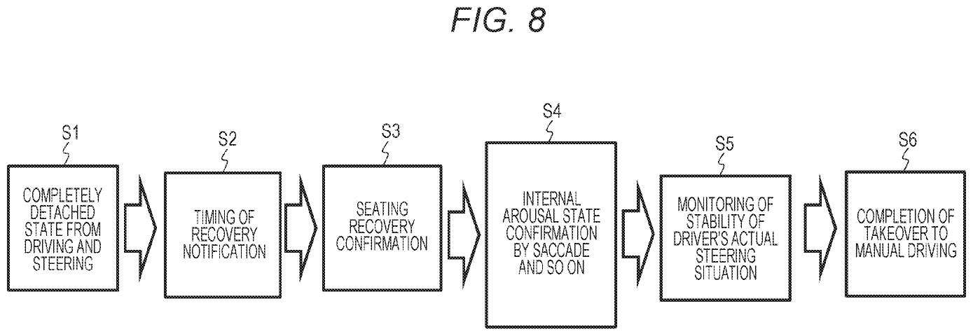

FIG. 8 schematically illustrates an example of a mode switching sequence from the automatic driving mode to the manual driving mode in the automatic driving control unit 112.

In step S1, the driver is in a state of being completely detached from the driving and steering. In this state, for example, the driver can execute a secondary task such as taking a nap, watching a video, concentrating on a game, and working with a visual tool such as a tablet or a smartphone. The work using the visual tool such as a tablet or a smart phone may be performed, for example, in a state where the driver's seat is displaced or in a seat different from the driver's seat.

When the vehicle approaches a section requiring manual driving recovery on the route, it is assumed that the time until the driver recovers greatly varies depending on the operation content at that time. With the notification just before the approach to the event, the time is insufficient to recover. In a case where the notification is made too early with respect to the approach of the event with a margin, the time to the timing actually required for recovery may be too long, depending on the state of the driver. As a result, if the situation where the notification is not performed at appropriate timing repeatedly occurs, the driver loses the reliability for the notification timing of the system, and the driver's consciousness for the notification decreases, and the driver's accurate treatment is neglected, accordingly. As a result, the risk of failing in takeover is increased, and at the same time, it becomes a factor to hinder comfort execution of the secondary task. Therefore, to enable the driver to start accurate driving recovery to the notification, the system needs to optimize the notification timing.

Step S2 is the timing of the manual driving recovery request notification described above with reference to FIG. 4. Notification of the driving recovery is issued to the driver using dynamic puptics such as vibration or a visual or auditory manner. The automatic driving control unit 112 monitors a steady state of the driver, for example, grasps the timing to issue the notification, and issues the notification at appropriate timing. That is, the system passively and constantly monitors the driver's secondary task execution state during the former passive monitoring period and can calculate optimal timing of optimal timing of the notification. It is desirable to continuously and constantly perform the passive monitoring in the period of step S1 and to calculate the recovery timing and issue the recovery notification according to recovery characteristics unique to the driver.

That is, it is desirable to learn the optimal recovery timing according to the recovery action pattern of the driver, the vehicle characteristics, and the like, and to present, to the driver, the statistically obtained optimal timing, which is required for the driver to normally recover from the automatic driving to the manual driving at a predetermined rate or higher. In this case, in a case where the driver does not responded to the notification for a certain period of time, a warning by sounding an alarm or the like is given.

In step S3, whether or not the driver has been seated and recovered is confirmed. In step S4, an internal arousal state of the driver is confirmed by analyzing a face or an eyeball behavior such as saccade. In step S5, stability of an actual steering situation of the driver is monitored. Then, in step S6, the takeover from the automatic driving to the manual driving is completed.

### [5. Control Processing Example in a Case of Traveling in Low-Speed Automatic Driving Permissible Area and High-Speed Automatic Driving Permissible Area.]

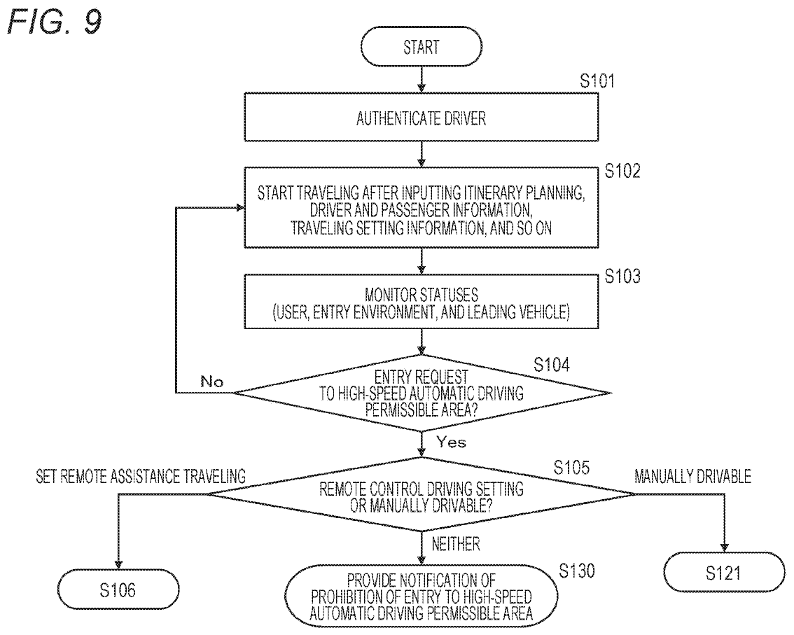

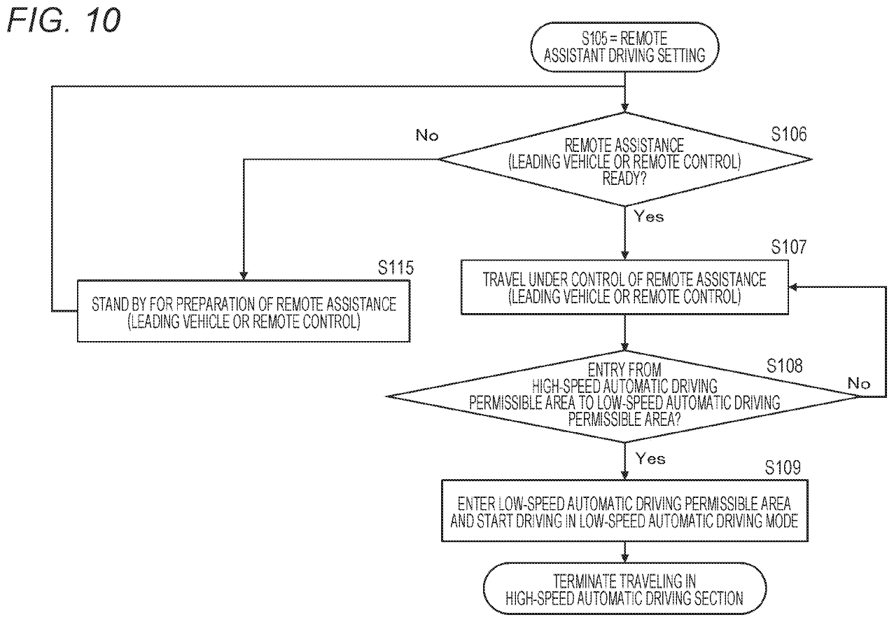

Next, a control processing example in a case of traveling in a low-speed automatic driving permissible area and a high-speed automatic driving permissible area will be described with reference to the flowchart in FIGS. 9 to 11.

As described above with reference to FIG. 2, For example, the automobile 10 in automatic driving at the low-speed automatic driving mode in a low-speed automatic driving permissible areas A 50a in FIG. 2 travels to another low-speed automatic driving permissible area B 50b at a distant place, the automobile 10 needs to pass through connecting roads including a general road, an expressway, and the like connecting these areas.

This connecting road is the high-speed automatic driving permissible section 70 where the automatic driving in the low-speed automatic driving mode is not permitted. Therefore, the automobile 10 switches the mode to the high-speed automatic driving mode in the high-speed automatic driving permissible section 70 and performs the automatic driving at a speed similar to other general vehicles. However, switching from the automatic driving to the manual driving is required when an emergency occurs such as an accident in the high-speed automatic driving permissible section 70. In this case, the driver needs to perform high-speed manual driving. For example, a section near an accident occurrence point 71 in FIG. 2 is set as a manual driving required section 72.

However, there is a possibility that the driver of the automobile 10 cannot perform the manual driving at a high speed similarly to the general vehicles, in the case where the driver is an elderly person, for example. In the case where the driver of the automatic driving vehicle lacks the ability of manual driving, as described above, the driver cannot switch the automatic driving to the manual driving, and measures such as an emergency stop needs to be taken. If such emergency measures occur frequently, traffic congestion will occur.

As described above, in the case where a person steers a car, it is necessary to accurately perform the three processes of “cognition, judgment, and operation” for various events that occur as the vehicle travels. In a conventional manually driven vehicle, the driver performs all of these processes. In the automatic driving vehicle, the automatic drive system that replace humans performs the “cognition, judgment, and operation”. However, when a section is set as the manual driving required section 72, due to occurrence of an accident or the like, as illustrated in FIG. 2, the driver needs to start the manual driving and needs to accurately perform the three processes of “cognition, judgment, and operation”. In the case where the driver of the automobile 10 is an elderly person, for example, and cannot accurately perform the three processes of “cognition, judgment, and operation”, the driver may not be able to start safe manual driving. In this case, switching to the manual driving cannot be performed, and measures such as emergency stop need to be taken, which causes traffic congestion with high possibility.

The present disclosure prevents occurrence of such problems, and performs entry control according to a manual driving ability of a driver in a case where a vehicle capable of automatic driving at a low speed and automatic driving at a high speed enters a high-speed automatic driving permissible area from a low-speed automatic driving permissible area.

Hereinafter, the control sequence will be described with reference to the flowchart in FIG. 9 and the subsequent drawings.

The processing of the flow illustrated in FIG. 9 and the subsequent drawings is executed by the mobile device or the information processing device mounted in the mobile device. Note that, hereinafter, description will be given on the assumption that the processing of the flow in FIG. 9 and the subsequent drawings is executed by the information processing device.

Hereinafter, processing of each step of the flow illustrated in FIG. 9 and the subsequent drawings will be described.

(Step S101)

First, in step S101, driver authentication, driver and passenger information input, and travel setting information registration processing are performed. The driver authentication is performed using knowledge authentication using a password, a personal identification number, and the like, biometric authentication using the face, a fingerprint, an iris of a pupil, a voice print, or the like, or the knowledge authentication and the biometric authentication together. By performing the driver authentication in this way, information corresponding to each driver can be accumulated and processing corresponding to each driver can be performed even in the case where a plurality of drivers drives the same vehicle.

(Step S102)

Next, in step S102, the driver operates the input unit 101 to perform destination setting, driver and passenger information input, travel setting information registration processing, and the like. In this case, the driver's input operation is performed on the basis of display on an instrument panel.

Note that, in the present embodiment, the case where the driver gets in the vehicle and sets the itinerary is described, but the itinerary may be set in advance with a smartphone or a personal computer before getting in the vehicle. Furthermore, the system may make a plan according to a schedule put in advance in the information processing device. Note that, at the time of setting the itinerary, processing of acquiring a so-called local dynamic map (LDM) in which road environment information, for example, travel map information of roads on which the vehicle travels is updated with high density on a constant basis, and selecting an optimum route is performed. Moreover, traveling advice information may be displayed on the basis of traffic jam information and the like obtained from the LDM.

In the driver and passenger information input processing in step S102, for example, presence/absence information of a driver or a passenger who can manually drive in a high-speed region is input. Furthermore, in the case where the high-speed automatic driving permissible area is included on the traveling route included in the input itinerary planning, the user can set whether or not to use a traveling support system in the high-speed automatic driving permissible area as the traveling setting information registration processing. For example, a request for a leading vehicle for driving support or a remote support request for travel control by remote control can be reserved in advance. As described above, the remote support request is either the remote driving control by a leading vehicle or the remote driving control by remote control from a driving control center.

Moreover, section setting information of the automatic driving section and the manual driving section and the like can be acquired from the local dynamic map (LDM) and confirmed in advance.

After these processes, traveling is started. Note that, the traveling is started in the low-speed automatic driving permissible area, and the automatic driving in the low-speed automatic driving mode is mainly executed, and the manual driving is executed as needed.

(Step S103)

Next, in step S103, status monitoring is executed. Data to be monitored includes driver status information, driver operation information, leading vehicle and remote control standby information, section setting information for the automatic driving section and the manual driving section on a traveling path.

(Step S104)

Next, in step S104, whether or not entry request to the high-speed automatic driving permissible area is issued is detected, and in the case where the entry request is issued, the processing proceeds to step S105. In the case where no entry request is issued, the processing returns to step S102, and the low-speed automatic driving is continued in the low-speed automatic driving permissible area.

Note that approach of the mobile device (automobile) to an entry position from the low-speed automatic driving permissible area to the high-speed automatic driving permissible area is detected by the environment information acquisition unit 13 illustrated in FIG. 3. For example, detection is performed on the basis of the information of the local dynamic map (LDM).

(Step S105)

In step S104, in the case where the entry request to the high-speed automatic driving permissible area is issued, the processing proceeds to step S105. In step S105, which of the following conditions the current state corresponds to is determined using the registration information in step S102 and the monitoring information in the low-speed automatic driving permissible area in step S103.

(a) There is a setting to travel with remote support (lead vehicle or remote control) in the high-speed area.

(b) Manual driving in the high-speed area is possible.

(c) Neither of the above (a) and (b).

In the case where it is determined that (a) there is a setting to travel with remote support (lead vehicle or remote control) in the high-speed area, the processing proceeds to step S106.

In the case where it is determined that (b) manual driving in the high-speed area is possible, the processing proceeds to step S121.

In the case where it is determined that (c) neither of the above (a) and (b), the processing proceeds to step S130, and a notification to prohibit entry to the high-speed automatic driving permissible area is performed. For example, “Entry to high-speed automatic driving permissible area is prohibited” is displayed on the display unit.

(Step S106)

In the determination processing in step S105, in the case where it is determined that (a) there is a setting to travel with remote support (lead vehicle or remote control) in the high-speed area, the processing proceeds to step S106. In step S106, whether or not remote driving support, that is, the leading vehicle or remote control is ready is determined. This determination processing is executed before entry to the high-speed automatic driving permissible area from the low-speed automatic driving permissible area.

Note that, in this determination processing, communication resources and other resources are also checked to see if communication with the leading vehicle or the remote control device can be continuously and stably performed. Moreover, standby points during remote support suspension are also checked.

In the case were the remote driving support, that is, the leading vehicle or remote control has been ready, and the resources and standby points have been checked in step S106, the processing proceeds to step S107. If not, the processing proceeds to step S115.

(Step S107)

In the case were the remote driving support, that is, the leading vehicle or remote control has been ready, and the resources and standby points have been checked in step S106, the processing proceeds to step S107. In step S107, the high-speed automatic driving is started in the high-speed automatic driving permissible area while receiving the driving support by the leading vehicle or remote control.

(Step S108)

Next, in step S108, whether or not the vehicle has reached the entry point from the high-speed automatic driving permissible area to the low-speed automatic driving permissible area. In the case where the vehicle has reached the entry point from the high-speed automatic driving permissible area to the low-speed automatic driving permissible area, the processing proceeds to step S109. In the case where the vehicle has not reached the entry point, the high-speed automatic driving is continued in the high-speed automatic driving permissible area while receiving the driving support by the leading vehicle or remote control in step S107.

(Step S109)

In step S109, the vehicle enters the low-speed automatic driving permissible area and starts traveling in the low-speed automatic driving mode.

(Step S115)

On the other hand, in the case were the remote driving support, that is, the leading vehicle or remote control has not been ready, and the resources and standby points have not been checked in step S106, the processing proceeds to step S115.

On the other hand, in step S115, in the case were the remote driving support, that is, the leading vehicle or remote control has not been ready, and the resources and standby points have not been checked, the processing stands by until the standby points are checked. The standby processing continues until the determination in step S106 becomes Yes. This standby processing is executed within the low-speed automatic driving permissible area.

(Step S121)

Next, the processing in step S121 and the subsequent steps in the case where it is determined that (b) manual driving in the high-speed area is possible, in the determination processing in step S105, will be described.

In step S121, whether the driver's manual driving skill level is high enough to allow full manual driving at high speed (full range manual driving) or the driver's manual driving skill level it is a low level that may require remote control from the outside. This is executed with reference to the registration information in the registration processing executed in step S102 and the monitoring result of the monitoring processing executed in step S103.

In the case where it is determined in step S121 that the driver's manual driving skill level is high enough to allow full manual driving at high speed (full range manual driving), the processing proceeds to step S122. On the other hand, it is determined that the driver's manual driving skill level it is a low level that may require remote control from the outside, the processing proceeds to step S125.

(Step S122)

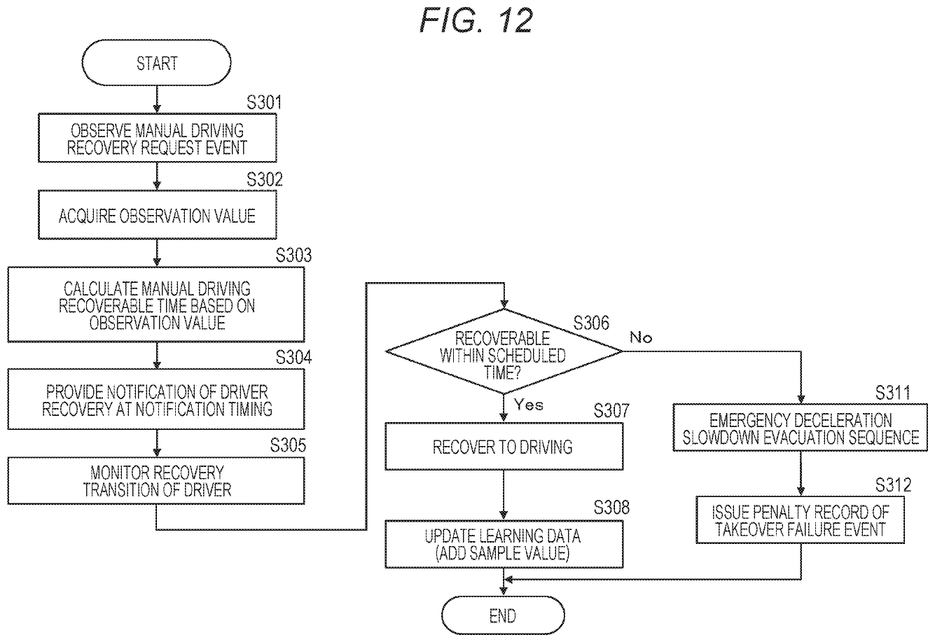

In the case where it is determined in step S121 that the driver's manual driving skill level is high enough to allow full manual driving at high speed (full range manual driving), the processing proceeds to step S122, and the high-speed automatic driving assuming the manual driving recover at emergency is started. Detailed sequence of the high-speed automatic driving will be described with reference to the flowchart in FIG. 12 below.

(Step S123)

Next, in step S123, whether or not the vehicle has reached the entry point from the high-speed automatic driving permissible area to the low-speed automatic driving permissible area. In the case where the vehicle has reached the entry point from the high-speed automatic driving permissible area to the low-speed automatic driving permissible area, the processing proceeds to step S124. In the case where the vehicle has not reached the entry point, the processing returns to step S122, and the high-speed automatic driving assuming the automatic driving recovery at emergency is continued.

(Step S124)

In step S124, the vehicle enters the low-speed automatic driving permissible area and starts traveling in the low-speed automatic driving mode.

(Step S125)

On the other hand, it is determined in step S121 that the driver's manual driving skill level it is a low level that may require remote control from the outside, the processing proceeds to step S125.

In step S125, the automatic driving in the high-speed automatic driving permissible area assuming the driving support at emergency is started. Therefore, after the remote support (leading vehicle or remote control) is prepared, the high-speed automatic driving in the high-speed automatic driving permissible area is started.

Note that the processing in step S125 is executed in the low-speed automatic driving permissible area.

(Step S126)

In step S126, whether or not necessity of automatic driving by driving support has occurred due to an accident or the like is determined.

In the case where the necessity of automatic driving by driving support has occurred, the processing proceeds to step S127. In the case where no necessity has occurred, the processing returns to step S125, and the high-speed automatic driving is continued in the

high-speed automatic driving permissible area.

(Step S127)

In step S126, in the case where the necessity of automatic driving by driving support has occurred, the processing proceeds to step S127. In step S127, the high-speed automatic driving is started in the high-speed automatic driving permissible area while receiving the driving support by the leading vehicle or remote control.

(Step S128)

Next, in step S128, whether or not the vehicle has reached the entry point from the high-speed automatic driving permissible area to the low-speed automatic driving permissible area. In the case where the vehicle has reached the entry point from the high-speed automatic driving permissible area to the low-speed automatic driving permissible area, the processing proceeds to step S129. In the case where the vehicle has not reached the entry point, the high-speed automatic driving is continued in the high-speed automatic driving permissible area while receiving the driving support by the leading vehicle or remote control in step S127.

(Step S129)

In step S129, the vehicle enters the low-speed automatic driving permissible area and starts traveling in the low-speed automatic driving mode.

### [6. Travel Control Sequence in High-Speed Automatic Driving Permissible Area]

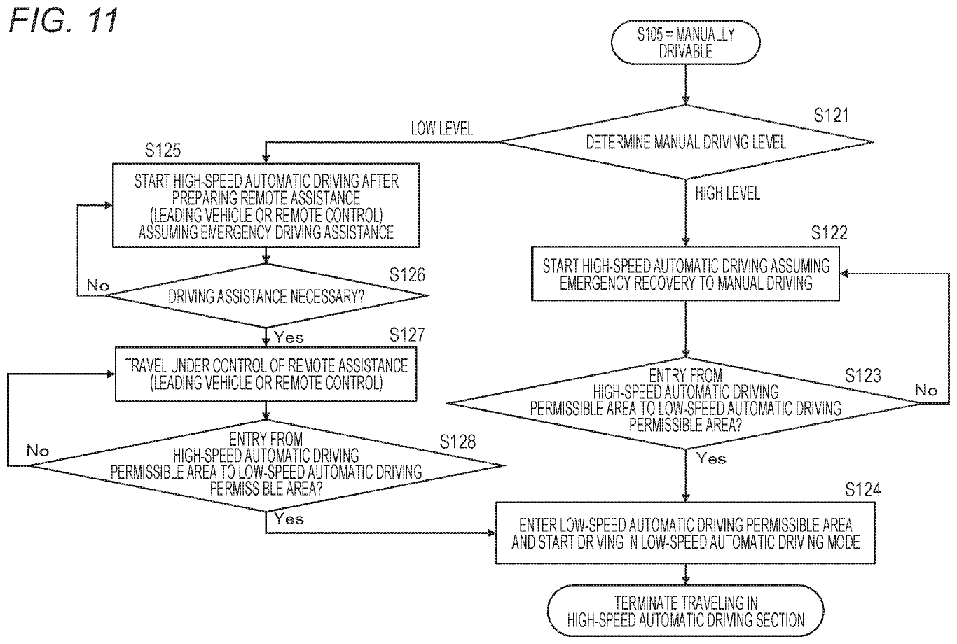

Next, the processing executed in step S122 of the flow illustrated in FIG. 11, that is, the details of the traveling control sequence in the high-speed automatic driving permissible area will be described with reference to the flowchart illustrated in FIG. 12. Processing of steps will be sequentially described.

(Step S301)

First, in step S301, the data processing unit of the mobile device or the data processing unit of the information processing device attached to the mobile device observes an occurrence event of a request for switching the automatic driving mode to the manual driving mode. Note that, hereinafter, the data processing unit of the mobile device or the data processing unit of the information processing device attached to the mobile device will be simply described as data processing unit.

In step S301, the data processing unit observes the occurrence event of the request for switching the automatic driving mode to the manual driving mode. This observation processing is performed on the basis of the local dynamic map (LDM) information.

The local dynamic map (LDM) distribution server generates the latest LDM timely reflecting area setting information regarding the low-speed automatic driving permissible area and the high-speed automatic driving permissible area described with reference to FIG. 2, and setting information of the accident occurrence point 71 and the manual driving request section 72 set therearound, for example, and transmits the generated LDM to the mobile device (automobile), as needed. The mobile device (automobile) can immediately get the current road condition on the basis of the received information from the LDM distribution server.

(Step S302)

Next, in step S302, the observation value is acquired. The observation value acquisition processing is performed in the driver information acquisition unit 12 and the environment information acquisition unit 13 illustrated in FIG. 3, for example. Note that these configurations correspond to the configurations of the data acquisition unit 102 and the detection unit 131 illustrated in FIG. 5.

The driver information acquisition unit 12 includes a camera and various sensors, and acquires the driver information, such as information for determining the arousal level of the driver, for example. The information is, for example, a line-of-sight direction, an eyeball behavior, and a pupil diameter acquired from an image including an eyeball area, and a facial expression acquired from an image including a face area. The driver information acquisition unit 12 further acquires the operation information of the operation units (steering wheel, accelerator, brake, and the like) of the driver.

In the observation value acquisition processing, the driver information indicating the driver's state, for example, whether or not the driver is taking a nap, whether or not the driver is looking ahead, or whether or not the driver is operating a tablet terminal, is acquired.

Furthermore, the environment information acquisition unit 13 acquires, for example, an image by an imaging unit installed in the mobile device 200, depth information, three-dimensional structure information, topographical information by sensors such as an LiDAR installed on a moving body, position information by a GPS, traffic light conditions, sign information, information from a communication device installed on an infrastructure such as a road, and the like.

(Step S303)

Next, in step S303, a manual driving recoverable time (=recovery delay time) is calculated. The data processing unit 11 of the information processing device receives, for example, the driver information acquired by the driver information acquisition unit 12 and the environment information acquired by the environment information acquisition unit 13 as inputs. Moreover, the data processing unit 11 estimates the time required by safe manual driving recovery (=manual driving recoverable time) on the basis of the current driver information and environment information, using a learning processing result (learning device) executed in advance.

In the processing of estimating the manual driving recoverable time (=recovery delay time) required by safe manual driving recovery, the processing (manual driving recoverable time estimation processing) using the personal identification information of the driver who is currently driving and the information of the type of the secondary task being currently executed as the observation information is performed.

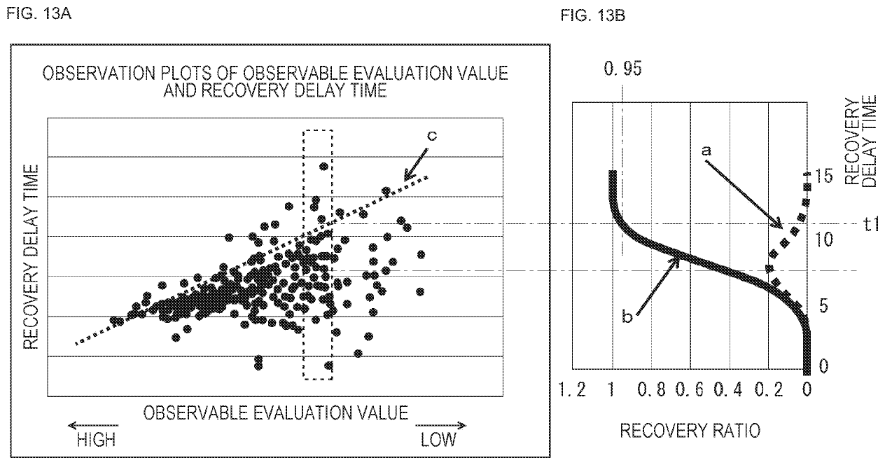

Note that a specific example of manual driving recoverable time estimation processing using a learning processing result (learning device) will be described below with reference to FIG. 13 and the like.

(Step S304)

Next, in step S304, a notification for prompting the driver to recover to driving is executed at the notification timing determined according to the recovery delay time calculated in step S303, that is, timing when an event to be taken over (the takeover section from the automatic driving to the manual driving or the cautioned traveling section from the automatic driving) approaches the recovery delay time. This notification is executed as, for example, the display processing described above with reference to FIG. 4. Alternatively, the notification may be executed as an alarm output or vibration of the steering wheel or the seat. For example, in the case where the driver is taking a nap, a notification method for waking the driver from the sleeping state is selected.

(Steps S305 to S308)

Next, in step S305, the recovery transition of the driver is monitored. Then, in step S306, whether or not the driver can recover to driving within the recovery delay time on the basis of a monitoring result in step S305. In the case where it is determined that the driver can recover to driving, the driver recovers to driving in step S307. Then, in step S308, the learning data is updated. That is, one sample value of the relationship information (observation plot) between the observable evaluation value and the actual recovery delay time regarding the initial type of the secondary task of the driver when the above-described recovery to driving is performed is added. After that, the processing is terminated. Note that, in the present embodiment, the learning is limited to the plot data generated at each event. However, in reality, the learning largely depends on the previous state (history) until the event occurs. Therefore, the estimation accuracy of the recovery delay required time from the observation value of the driver state may be further improved by performing multidimensional learning.

(Steps S311 and S312)

Furthermore, when it is determined in step S306 that recovery to driving is not possible, a deceleration slowdown evacuation sequence is executed from the start to stop in step S311. Next, in step S312, a record of penalty of a takeover defect event is issued, and the processing is terminated. Note that the record of the penalty is stored in the storage unit. However, there is also the idea that it is sufficient to finally recover the delay even if the recovery operation is temporarily delayed on the way. Therefore, penalty recording processing may be performed by comprehensively determining such a situation.

### [7. Specific Example of Manual Driving Recoverable Time Estimation Processing]

Next, a specific example of manual driving recoverable time estimation processing executed in step S303 of the flow described with reference to FIG. 12 will be described. The learning device used in the processing of estimating the manual driving recoverable time executed in step S303 can be set for each driver or set to include the type of the secondary information during the automatic driving to the observation information.

In this case, the processing (manual driving recoverable time estimation processing) using the personal identification information of the driver who is currently driving and the information of the type of the secondary task being currently executed as the observation information is performed.

FIG. 13(a) illustrates an example of distribution of a plurality of pieces of relationship information (observation plots) between the observable evaluation value corresponding to an observation value and the recovery delay time (=manual driving recoverable time). This example corresponds to a type of a certain secondary task of a certain driver. To calculate the recovery delay time from the plurality of pieces of relationship information (observation plots), the relationship information (observation plot) in an area (illustrated by the broken-line rectangular frame) having a certain width in an evaluation value direction corresponding to the acquired observation value is extracted. A dotted line c in the figure represents a boundary line of when the recovery delay time at which the recovery ratio is 0.95 in FIG. 13(b) described below is observed with different observation values of the driver.

By issuing the recovery notification from the automatic driving to the manual driving or an alarm to the driver for a longer time, that is, in an earlier time, than the dotted line c, the driver's successful recovery from the automatic driving to the manual driving is secured at the ratio of 0.95 or higher. Note that a target value (requested recovery ratio) for allowing the driver to normally recover from the automatic driving to the manual driving for each corresponding section is determined by the roadside from the necessity of infrastructure, for example, and is provided to the individual vehicle passing through the section

Note that, in a case where the vehicle does not interfere with surroundings even if the vehicle stops on the road, the vehicle is only required to be stopped, or the vehicle is only required to be decelerated to the speed handleable by the system. Normally, stopping a vehicle on a traveling road is not always desirable, and therefore, a high recovery ratio is desirable as a default setting. In particular, in a specific route such as metropolitan expressway, an extremely high recovery ratio may be required even if the infrastructure does not provide update information.

FIG. 13(b) illustrates a relationship between the recovery delay time and the recovery ratio obtained from the plurality of pieces of extracted relationship information (observation plots). Here, a curve a illustrates an independent success ratio at each recovery delay time, and a curve b illustrates a cumulative success ratio at each recovery delay time. In this case, a recovery delay time t1 is calculated such that the success ratio becomes a predetermined ratio, that is, the success ratio becomes 0.95 in the illustrated example, on the basis of the curve b.

The data processing unit 11 performs the calculation processing by acquiring the distribution information of the plurality of pieces of relationship information (observation plots) between the observable evaluation value and the recovery delay time stored in and acquired from the storage unit 240 in the past.

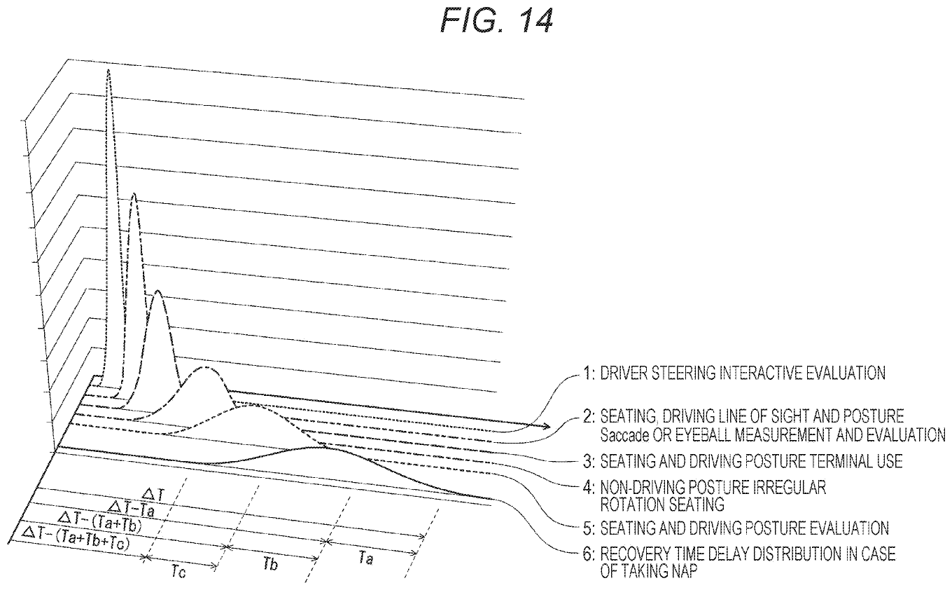

FIG. 14 is a graph for describing the manual driving recoverable time according to a type of processing (secondary task) executed by the driver in the automatic driving mode when the driver is detached from the driving and steering operation.

Each distribution profile corresponds to the curve a illustrated in FIG. 13(b), which is predicted on the basis of the observed value, that is, the driver state. That is, to complete the takeover from the automatic driving to the manual driving at the takeover point with a necessary recovery ratio, whether or not a state actually reaches a necessary state required for recovery at each recovery stage is monitored until the takeover is completed on the basis of the time t1 when the profile (the recovery ratio profile in FIG. 13(b)) becomes a desired value by reference to the past characteristics required for the driver to recovery, from observation values capable of evaluating the arousal level of the driver detected at each stage.

For example, the initial curve in the case of taking a nap has cumulative average distribution in the case of estimating a sleep level from observation information such as breathing and pulse waves that are passively monitored during the nap period in the automatic driving, and viewing recovery delay characteristics of the driver after issuing a wakeup alarm. Each halfway distribution is determined according to the driver's state observed after the driver wakes up and in a subsequent movement recovery procedure. “6. In the case of taking a nap” illustrated in the drawing is observed and the right timing in time for the wakeup alarm is determined, and a halfway process thereafter shows the recovery time distribution in a recovery budget predicted from an observable driver state evaluation value at a predicted intermediate point.

Observation as to not violating a remaining takeover time limit, which gradually decreases until the takeover, is continued halfway, and in the case where there is a violation risk, the vehicle is decelerated, and a time delay is generated, for example. Note that, for example, regarding distribution of recovery starting from “4. Non-driving posture irregular rotation seating” without the steps of “6. In the case of taking a nap” and “5. Seated”, the process of recovery starts from initial situation recognition grasping. Therefore, in the case of starting from the situation recognition in the “4. Non-driving posture irregular rotation seating” posture from the beginning, the time to recognize the situation is long. Whereas in the state of “4. Non-driving posture irregular rotation seating” posture as an on-going process starting from “6. In the case of taking a nap”, the thinking process is in a recovery consciousness process even through the item is the same.

Note that the relationship information between the observable evaluation value and the recovery delay time of the driver currently driving may not be sufficiently stored in the storage unit. In that case, for example, recovery characteristic information generated on the basis of information collected from driver population of the same age group is stored in the storage unit, and the recovery delay time t1 can be calculated using the recovery characteristic information as assumed distribution information of recovery provided in advance. In the recovery information, the driver specific characteristics have not sufficiently been learned. Therefore, the same recovery ratio may be used on the basis of the information, or a higher recovery ratio may be set. Note that an ergonomically inexperienced user is expected to recover early in the beginning of use because the user is cautious. Then, the driver himself/herself adapts to the action in accordance with the notification of the system as he/she gets accustomed to the system. Note that, in the case of using different vehicles in logistics business that operates many vehicles, in vehicle operation business that operates buses, taxis, or the like, or sharing cars and rental cars, personal authentication of the driver is performed, the observable information and recovery characteristics of driving are managed and learned in a concentrated or distributed manner on a remote server or the like, and the data of the recovery characteristics is not necessarily stored in the individual vehicles and may be remotely learned and processed, and stored.

Furthermore, because the notification timing is important, the recovery ratio has been described using the uniform time to success or failure. However, the success or failure from the automatic driving to the manual driving is not limited to the binary success or failure, and determination further extended to recovery takeover quality may be made. That is, delay time of recovery procedure transition to actual recovery confirmation, recovery start delay to the notification, stagnation in a halfway recovery operation, and the like within allowed time may be further input to the learning device as recovery quality evaluation values.

### [8. Configuration Example of Information Processing Device]

The above-processing can be executed by applying the configuration of the mobile device described with reference to FIG. 5. However, part of the processing can be executed by an information processing device attachable to and detachable from the mobile device or a server, for example.

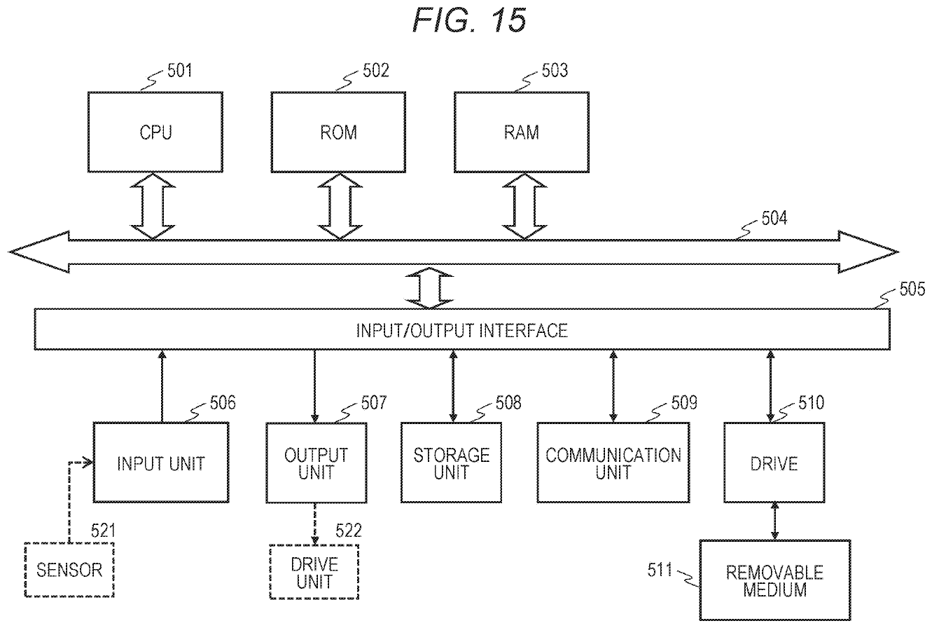

Next, a hardware configuration example of the information processing device or the server will be described with reference to FIG. 15.

FIG. 15 is a diagram illustrating a hardware configuration example of the information processing device or the server.

A central processing unit (CPU) 501 functions as a data processing unit that execute various types of processing according to a program stored in a read only memory (ROM) 502 or a storage unit 508. For example, the CPU 501 executes processing according to the sequence described in the above embodiment.

A random access memory (RAM) 503 stores the program executed by the CPU 501, data, and the like. These CPU 501, ROM 502, and RAM 503 are mutually connected by a bus 504.

The CPU 501 is connected to an input/output interface 505 via the bus 504. An input unit 506 including various switches, a keyboard, a touch panel, a mouse, a microphone, and a state data acquisition unit such as a sensor, a camera, and GPS, and an output unit 507 including a display, a speaker, and the like are connected to the input/output interface 505.

Note that input information from a sensor 521 is also input to the input unit 506.

Furthermore, the output unit 507 also outputs drive information for a drive unit 522 of the mobile device.

The CPU 501 receives commands, state data, and the like input from the input unit 506, executes various types of information, and outputs processing results to the output unit 507, for example.

The storage unit 508 connected to the input/output interface 505 includes, for example, a hard disk and the like, and stores the program executed by the CPU 501 and various data. A communication unit 509 functions as a transmission/reception unit for data communication via a network such as the Internet or a local area network, and communicates with an external device.

A drive 510 connected to the input/output interface 505 drives a removable medium 511 such as a magnetic disk, an optical disk, a magneto-optical disk, or a semiconductor memory such as a memory card, and executes data recording or reading.

### [9. Conclusion of Configurations of Present Disclosure]

The examples of the present disclosure have been described in detail with reference to the specific examples. However, it is obvious that those skilled in the art can make modifications and substitutions of the examples without departing from the gist of the present disclosure. That is, the present invention has been disclosed in the form of exemplification, and should not be restrictively interpreted. To judge the gist of the present disclosure, the scope of claims should be taken into consideration.

Note that the technology disclosed in the present specification can have the following configurations.

(1) An information processing device including a data processing unit configured to determine a manual driving ability of a driver of a mobile device and execute entry control according to a determination result when the mobile device enters an automatic driving permissible area.

(2) The information processing device according to (1), in which

the data processing unit determines the manual driving ability at a high speed of the driver of the mobile device and executes the entry control according to the determination result when the mobile device enters a high-speed automatic driving permissible area from a low-speed automatic driving permissible area.

(3) The information processing device according to (1) or (2), in which

the data processing unit determines presence or absence of a remote support setting of the mobile device and executes the entry control according to the determination result.

(4) The information processing device according to (3), in which

the remote support setting is either remote driving control of the mobile device by a leading vehicle of the mobile device or remote driving control of the mobile device from a driving control center.

(5) The information processing device according to any one of (2) to (4), in which,

in a case where there is no manual driving ability at a high speed of the driver of the mobile device, and moreover in a case where there is no remote support setting at a high speed of the mobile device, the data processing unit executes a notification of prohibiting an entry to the high-speed automatic driving permissible area.

(6) The information processing device according to any one of (2) to (5), in which

the data processing unit executes processing of determining the manual driving ability at a high speed of the driver of the mobile device on the basis of monitoring information including operation information of the driver in the low-speed automatic driving permissible area.

(7) The information processing device according to any one of (2) to (6), in which

the data processing unit executes notification processing of a manual driving recovery request notification according to occurrence of a manual driving request section after the mobile device enters the high-speed automatic driving permissible area.

(8) The information processing device according to (7), in which

the data processing unit executes notification processing of the driving recovery request notification, using at least one of a display unit, a sound output unit, or a vibrator.

(9) The information processing device according to (7) or (8), in which

the data processing unit calculates a manual driving recoverable time required for the driver who is executing automatic driving, and determines notification timing of the manual driving recovery request notification on the basis of the calculated time.

(10) The information processing device according to any one of (7) to (9), in which

the data processing unit calculates the manual driving recoverable time, using learning data for each driver.

(11) The information processing device according to (10), in which

the data processing unit acquires operation information of the driver after switching from automatic driving to manual driving and executes learning data update processing.

(12) A mobile device including:

an environment information acquisition unit configured to detect approach of the mobile device to an entry position from a low-speed automatic driving permissible area to a high-speed automatic driving permissible area; and

a data processing unit configured to determine a manual driving ability at a high speed of a driver of the mobile device and execute entry control according to a determination result when the mobile device enters a high-speed automatic driving permissible area from a low-speed automatic driving permissible area.

(13) The mobile device according to (12), in which

the data processing unit determines presence or absence of a remote support setting of the mobile device and execute the entry control according to the determination result.

(14) The mobile device according to (12), in which

the data processing unit executes processing of determining presence or absence of a driver capable of manual driving at a high speed of the mobile device on the basis of monitoring information including operation information of the driver in the low-speed automatic driving permissible area.

(15) An information processing system including a server configured to distribute a local dynamic map (LDM) and a mobile device configured to receive distribution data of the server, in which

the server

distributes the local dynamic map (LDM) on which area setting information regarding a low-speed automatic driving permissible area and a high-speed automatic driving permissible area, and

the mobile device includes

a communication unit that receives the local dynamic map (LDM), and

a data processing unit that determines a manual driving ability at a high speed of a driver of the mobile device and executes entry control according to a determination result when the mobile device enters the high-speed automatic driving permissible area from the low-speed automatic driving permissible area.

(16) An information processing method executed in an information processing device, the information processing method including

by a data processing unit, determining a manual driving ability of a driver of a mobile device and executing entry control according to a determination result when the mobile device enters an automatic driving permissible area.

(17) A program for causing an information processing device to execute information processing including

causing a data processing unit to determine a manual driving ability of a driver of a mobile device and execute entry control according to a determination result when the mobile device enters an automatic driving permissible area.

Furthermore, the series of processing described in the description can be executed by hardware, software, or a combined configuration of the hardware and software. In the case of executing the processing by software, a program, in which the processing sequence is recorded, can be installed in a memory of a computer incorporated in dedicated hardware and executed by the computer, or the program can be installed in and executed by a general-purpose computer capable of executing various types of processing. For example, the program can be recorded in the recording medium in advance. Other than the installation from the recording medium to the computer, the program can be received via a network such as a local area network (LAN) or the Internet and installed in a recording medium such as a built-in hard disk.

Note that the various types of processing described in the description may be executed not only in chronological order as described but also in parallel or individually depending on the processing capability of the device that executes the process or as required. Furthermore, the system in the present description is a logical aggregate configuration of a plurality of devices, and is not limited to devices having respective configurations within the same housing.

### INDUSTRIAL APPLICABILITY

As described above, according to a configuration of an embodiment of the present disclosure, a configuration to execute entry control to a high-speed automatic driving permissible area according to a determination result of a manual driving ability of a driver is implemented.

Specifically, for example, an entry of the mobile device from a low-speed automatic driving permissible area to the high-speed automatic driving permissible area is controlled on the basis of the determination result of the manual driving ability at a high speed of the driver. Moreover, the entry control is executed according to the presence or absence of a setting of remote driving control of the mobile device from a leading vehicle or a driving control center. In a case where there is no manual driving ability at a high speed of the driver of the mobile device, and moreover in a case where there is no remote support setting at a high speed of the mobile device, the data processing unit prohibits an entry to the high-speed automatic driving permissible area. The data processing unit determines the manual driving ability at a high speed of the driver of the mobile device on the basis of monitoring information including operation information of the driver in the low-speed automatic driving permissible area.

For example, the low-speed automatic driving traveling is performed under situations where no support is expected, whereas entry to higher-speed general roads and highways is permitted in a state where the driver has a driving and steering ability or under support of vehicles ahead or remote support. By performing such control, it is possible to provide means of transportation for people with poor public transportation and to expand their range.

With the present configuration, the configuration to execute entry control to the high-speed automatic driving permissible area according to the determination result of the manual driving ability of the driver is implemented.

### REFERENCE SIGNS LIST

10 Automobile
11 Data processing unit
12 Driver information acquisition unit
13 Environment information acquisition unit
14 Communication unit
15 Notification unit
20 Driver
30 Server
100 Mobile device
101 Input unit
102 Data acquisition unit
103 Communication unit
104 In-vehicle device
105 Output control unit
106 Output unit
107 Drive system control unit
108 Drive system
109 Body system control unit
110 Body system
111 Storage unit
112 Automatic driving control unit
121 Communication network
131 Detection unit
132 Self-position estimation unit
133 State analysis unit
134 Planning unit
135 Motion control unit
141 Vehicle exterior information detection unit
142 Vehicle interior information detection unit
143 Vehicle state detection unit
151 Map analysis unit
152 Traffic rule recognition unit
153 State recognition unit
154 State prediction unit
155 Safety determination unit (learning processing unit)
161 Route planning unit
162 Action planning unit
163 Motion planning unit
171 Emergency avoidance unit
172 Acceleration and deceleration control unit
173 Direction control unit
501 CPU
502 ROM
503 RAM
504 Bus
505 Input/output interface
506 Input unit
507 Output unit
508 Storage unit
509 Communication unit
510 Drive
511 Removable medium
521 Sensor
522 Drive unit

1. An information processing device comprising a data processing unit configured to determine a manual driving ability of a driver of a mobile device and execute entry control according to a determination result when the mobile device enters an automatic driving permissible area.

2. The information processing device according to claim 1, wherein
the data processing unit determines the manual driving ability at a high speed of the driver of the mobile device and executes the entry control according to the determination result when the mobile device enters a high-speed automatic driving permissible area from a low-speed automatic driving permissible area.

3. The information processing device according to claim 1, wherein
the data processing unit determines presence or absence of a remote support setting of the mobile device and executes the entry control according to the determination result.

4. The information processing device according to claim 3, wherein
the remote support setting is either remote driving control of the mobile device by a leading vehicle of the mobile device or remote driving control of the mobile device from a driving control center.

5. The information processing device according to claim 2, wherein,
in a case where there is no manual driving ability at a high speed of the driver of the mobile device, and moreover in a case where there is no remote support setting at a high speed of the mobile device, the data processing unit executes a notification of prohibiting an entry to the high-speed automatic driving permissible area.

6. The information processing device according to claim 2, wherein
the data processing unit executes processing of determining the manual driving ability at a high speed of the driver of the mobile device on a basis of monitoring information including operation information of the driver in the low-speed automatic driving permissible area.

7. The information processing device according to claim 2, wherein
the data processing unit executes notification processing of a manual driving recovery request notification according to occurrence of a manual driving request section after the mobile device enters the high-speed automatic driving permissible area.

8. The information processing device according to claim 7, wherein
the data processing unit executes notification processing of the driving recovery request notification, using at least one of a display unit, a sound output unit, or a vibrator.

9. The information processing device according to claim 7, wherein
the data processing unit calculates a manual driving recoverable time required for the driver who is executing automatic driving, and determines notification timing of the manual driving recovery request notification on a basis of the calculated time.

10. The information processing device according to claim 7, wherein
the data processing unit calculates the manual driving recoverable time, using learning data for each driver.

11. The information processing device according to claim 10 wherein
the data processing unit acquires operation information of the driver after switching from automatic driving to manual driving and executes learning data update processing.

12. A mobile device comprising:
an environment information acquisition unit configured to detect approach of the mobile device to an entry position from a low-speed automatic driving permissible area to a high-speed automatic driving permissible area; and
a data processing unit configured to determine a manual driving ability at a high speed of a driver of the mobile device and execute entry control according to a determination result when the mobile device enters a high-speed automatic driving permissible area from a low-speed automatic driving permissible area.

13. The mobile device according to claim 12, wherein
the data processing unit determines presence or absence of a remote support setting of the mobile device and execute the entry control according to the determination result.

14. The mobile device according to claim 12, wherein
the data processing unit executes processing of determining presence or absence of a driver capable of manual driving at a high speed of the mobile device on a basis of monitoring information including operation information of the driver in the low-speed automatic driving permissible area.

15. An information processing system comprising a server configured to distribute a local dynamic map (LDM) and a mobile device configured to receive distribution data of the server, wherein
the server
distributes the local dynamic map (LDM) on which area setting information regarding a low-speed automatic driving permissible area and a high-speed automatic driving permissible area, and
the mobile device includes
a communication unit that receives the local dynamic map (LDM), and
a data processing unit that determines a manual driving ability at a high speed of a driver of the mobile device and executes entry control according to a determination result when the mobile device enters the high-speed automatic driving permissible area from the low-speed automatic driving permissible area.

16. An information processing method executed in an information processing device, the information processing method comprising
by a data processing unit, determining a manual driving ability of a driver of a mobile device and executing entry control according to a determination result when the mobile device enters an automatic driving permissible area.

17. A program for causing an information processing device to execute information processing comprising
causing a data processing unit to determine a manual driving ability of a driver of a mobile device and execute entry control according to a determination result when the mobile device enters an automatic driving permissible area.
